(19) United States
(12) Patent Application Publication
(10) Pub. No.: US 2015/0089432 A1
(43) Pub. Date: Mar. 26, 2015

(54) QUICK DATA ENTRY SYSTEMS AND METHODS

(71) Applicant: Farzan Fallah, San Jose, CA (US)

(72) Inventor: Farzan Fallah, San Jose, CA (US)

(73) Assignee: idelan inc., San Jose, CA (US)

(21) Appl. No.: 14/474,130

(22) Filed: Aug. 30, 2014

Related U.S. Application Data
(60) Provisional application No. 61/872,829, filed on Sep. 2, 2013.

(51) Int. Cl. G06F 3/0488; G06F 3/0484

(52) U.S. Cl. CPC G06F 3/04883; G06F 3/04842
USPC 715/773

(57) ABSTRACT

A system for inputting data in an electronic device comprising: a segmented pattern on a touch sensitive graphical user interface; a numeric value associated to each of the segments; a character table stored in the electronic device, the said character table having at least one set of numeric values associated to at least one character; a set of characters displayed on the segmented pattern, each said character associated to at least one segment of the segmented pattern and the numeric value of that said segment in at least one set of the numeric values stored in the character table and the said set associated to the said character; an input signal received on at least one segment to provide an input having numeric values; a matched character determined according to input having numeric values and the character table; wherein the matched character is displayed on the touch sensitive graphical user interface of an electronic device, stored and the segmented pattern on the touch sensitive graphical user interface of the electronic device is reset.

This application claims priority to provisional patent application number U.S. 61/872,829 filed Sep. 2, 2013 and entitled “Quick data entry system” the entire content of which is incorporated herein by reference.

The present invention generally relates to electronic devices and in particular to operational control of such devices with a touch sensitive screen.

Finding an easier method to input characters into a digital system is a hot topic in the field of computer-human interaction. While for systems such as desktops or laptops, physical keyboards are the accepted solution, for smaller systems such as smart phones, using a large physical keyboard is not practical. Current smart phones use a small physical keyboard with small keys which are not easy to use especially for people with large fingers. Furthermore, the small number of keys in such keyboards means that some characters cannot be entered into the digital system easily. Virtual keyboards are another solution, which have become popular thanks to the progress in manufacturing touch screens, but the number of keys that can be displayed on a touch screen is limited by the small size of the smart phones' screens.

This invention describes a system/method/device for inputting characters, symbols into a digital system such as a smart phone. It uses a pattern to guide the user in writing glyphs, characters, or symbols. As a result, it will be easier for the digital system to detect the handwriting. To increase the data entry speed, the system/method/device allows some characters to be entered by simply tapping on the segments of the pattern or dragging a finger on a single or multiple segments (fast data entry).

These and other features, aspects and advantages of the present invention will become better understood with reference to the following description and claims.

### SUMMARY OF THE INVENTION

The present invention generally relates to electronic devices and in particular to operational control of such devices with a touch sensitive screen.

According to one embodiment, a system for inputting data in an electronic device is provided, the system comprising: a segmented pattern on a touch sensitive graphical user interface of an electronic device, the segmented pattern having at least two segments; a numeric value in the electronic device associated to each of the at least two segments; a character table stored in the electronic device, the said character table having at least one set of numeric values associated to at least one character; a set of characters displayed on the segmented pattern, each said character associated to at least one segment of the segmented pattern, and the numeric value of that said segment is in at least one set of the numeric values associated to the said character and stored in the character table; an input signal received on at least one segment of the segmented pattern to provide an input having numeric values associated with each of the segments; a matched character determined by the electronic device according to input having numeric values and the character table;

wherein the matched character is displayed on the touch sensitive graphical user interface of an electronic device and stored in the electronic device and the segmented pattern on the touch sensitive graphical user interface of the electronic device is reset.

According to another embodiment, a system for inputting data in an electronic device is provided, the system comprising: a segmented pattern on a touch sensitive graphical user interface of an electronic device, the segmented pattern having at least two segments; a numeric value in the electronic device associated to each of the at least two segments; a character table stored in the electronic device, the said character table having at least one set of numeric values associated to at least one character; a set of characters displayed on the segmented pattern, each said character associated to one segment of the segmented pattern and the numeric value of that said segment is in at least one set of the numeric values associated to the said character and stored in the character table; an input signal received on at least one segment of the segmented pattern to provide an input having numeric values associated with each of the segments; a sequence of at least one segment determined by the electronic device according to the input having numeric values and the character table; a matched character determined by the electronic device according to input having numeric values, the sequence and the character table; wherein the matched character is displayed on the touch sensitive graphical user interface of an electronic device and stored in the electronic device and the segmented pattern on the touch sensitive graphical user interface of the electronic device is reset.

According to another embodiment, a system for inputting data in an electronic device is provided, the system comprising: a segmented pattern on a touch sensitive graphical user interface of an electronic device, the segmented pattern having at least two segments and restricting input signals according to a set of predetermined rules; a set of characters displayed on the segmented pattern; an input signal received on at least a portion of a segment to provide an input having the coordinates of touched points; a matched character determined by the electronic device according to input having the coordinates of touched points and at least one algorithm; wherein the matched character is displayed on the touch sensitive graphical user interface of an electronic device and stored in the electronic device and the segmented pattern on the touch sensitive graphical user interface of the electronic device is reset.

These and other features, aspects and advantages of the present invention will become better understood with reference to the following description and claims.

### BRIEF DESCRIPTION OF THE DRAWINGS

FIG. 1a depicts a segmented pattern which can be used for inputting information according to the present invention;

FIG. 1b depicts a line drawn on a segmented pattern according to the present invention;

FIG. 1c depicts a character written on a segmented pattern according to the present invention;

FIG. 2 depicts numbers associated with segments according to the present invention;

FIG. 3a depicts a table with prewritten entries according to the present invention;

FIG. 3b depicts a table with prewritten entries according to the present invention;

FIG. 3c depicts a table with prewritten entries according to the present invention;

FIG. 4 depicts a flowchart according to the present invention;

FIG. 5a depicts a segment with three characters “a”, “b”, and “c” assigned to the segment and displayed on the segment;

FIG. 5b depicts a segment with three characters “a”, “b”, and “c” assigned to the segment and displayed on the segment; the figure also displays how the first character “a” can be entered by dragging one's finger on the segment from left to right;

FIG. 5c depicts a segment with three characters “a”, “b”, and “c” assigned to the segment and displayed on the segment; the figure also displays how the second character “b” can be entered by tapping on the segment;

FIG. 5d depicts a segment with three characters “a”, “b”, and “c” assigned to the segment and displayed on the segment; the figure also displays how the third character “c” can be entered by dragging one's finger on the segment from right to left;

FIG. 5e depicts a segment with three uppercase characters “A”, “B”, and “C” assigned to the segment and displayed on the segment;

FIG. 5f depicts a segment with five characters “a”, “b”, “c”, “!”, and “?” assigned to the segment; “a”, “b” and “c” are displayed on the segment, while “!”, and “?” are displayed outside (above) the segment; the figure also displays how character “!” can be entered by dragging one's finger on the segment from left to right and then right to left;

FIG. 5g depicts a segment with five characters “a”, “b”, “c”, “!”, and “?” assigned to the segment; “a”, “b” and “c” are displayed on the segment, while “!”, and “?” are displayed outside (above) the segment; the figure also displays how character “?” can be entered by dragging one's finger on the segment from right to left and then left to right;

FIG. 5h depicts a segmented pattern which can be used for inputting information according to the present invention;

FIG. 5i depicts a segmented pattern which can be used for inputting information according to the present invention;

FIG. 5j depicts a segment and how the end gesture of moving the finger slightly towards left can be combined with tapping on the segment;

FIG. 5k depicts a segment with three characters “d”, “e”, and “f” assigned to the segment and displayed on the segment; the figure also displays how the first character “d” can be entered by dragging one's finger upward on the segment;

FIG. 5l depicts a segment with three characters “d”, “e”, and “f” assigned to the segment and displayed on the segment; the figure also shows how the end gesture of moving the finger slightly towards left can be performed after dragging the finger upward on the segment;

FIG. 5m depicts a segment with three characters “d”, “e”, and “f” assigned to the segment and displayed on the segment; the figure also shows how the end gesture of moving the finger slightly towards right can be performed after dragging the finger upward on the segment;

FIG. 5n depicts a segment with three characters “d”, “e”, and “f” assigned to the segment and displayed on the segment; the figure also shows how the end gesture of moving the finger slightly outside the segment can be performed;

FIG. 5o depicts a segment with three characters “d”, “e”, and “f” assigned to the segment and displayed on the segment; the figure also shows how the end gesture of moving the finger in the reverse direction can be performed after dragging finger upward on the segment;

FIG. 5p depicts a segment with three characters “d”, “e”, and “f” assigned to the segment and displayed on the segment; the figure also shows how the finger can be kept on the touch screen after dragging finger upward on the segment;

FIG. 5q depicts a segment with three characters “g”, “h”, and “i” assigned to the segment and displayed on the segment; the figure also shows how the end gesture can be used to enter character “I”;

FIG. 5r depicts a segment with three characters “g”, “h”, and “i” assigned to the segment and displayed on the segment; the figure also shows how dragging finger on the segment and the end gesture can be used to write “g” (i.e., “g” followed by a space);

FIG. 5s depicts a segmented pattern which can be used for inputting English letters a-z, digits 0-9, and some punctuation according to the present invention;

FIG. 5t depicts a segmented pattern which can be used for inputting Korean characters, digits 0-9, and some punctuation displayed on the pattern;

FIG. 6a depicts a segment which can be used for inputting Japanese Katakana characters corresponding to consonant “K”;

FIG. 6b depicts a segment which can be used for inputting Japanese Katakana characters corresponding to vowels “a”, “i”, “u”, “e”, and “o”;

FIG. 6c shows a table of Japanese Katakana characters that can be inputted using the present invention;

FIG. 6d depicts a segment which can be used for inputting Japanese Katakana characters;

FIG. 6e shows a table of Japanese Hiragana characters that can be inputted using the present invention;

FIG. 6f depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6g depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6h depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6i depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6j depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6k depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6l depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6m depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6n depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6o depicts a segment which can be used for entering five characters “ [symbol] ”, “ [symbol] ”, “ [symbol] ”, “ [symbol] ”, and “ [symbol] ”; the figure displays how character “ [symbol] ” can be entered;

FIG. 6p depicts a segment with three sets of characters assigned to it;

FIG. 6q depicts a segment with character “ [symbol] ” assigned to the segment;

FIG. 6r depicts a segment with character “ [symbol] ” assigned to the segment;

FIG. 6s depicts a segment with character “ [symbol] ” assigned to the segment;

FIG. 6t depicts a segment with character “ [symbol] ” assigned to the segment;

FIG. 6u depicts a segment with character “ [symbol] ” assigned to the segment;

FIG. 6v shows a table of Japanese Katakana characters that can be inputted using the present invention;

FIG. 6w shows a table of Japanese Hiragana characters that can be inputted using the present invention;

FIG. 6x depicts a segmented pattern which can be used for inputting information according to the present invention;

FIG. 6y depicts a segmented pattern which can be used for inputting information according to the present invention;

FIG. 7a depicts a character written on a segmented pattern according to the present invention;

FIG. 7b depicts “:” written on a segmented pattern according to the present invention;

FIG. 7c depicts character “i” written on a segmented pattern according to the present invention;

FIG. 8a depicts a character written on a segmented pattern according to the present invention;

FIG. 8b depicts a character written on a segmented pattern according to the present invention;

FIG. 9 depicts a segmented pattern according to the present invention;

FIG. 10 depicts “for all” operator written on a segmented pattern according to the present invention;

FIG. 11 depicts an alternative segmented pattern according to the present invention;

FIG. 12 depicts an alternative segmented pattern according to the present invention;

FIG. 13a depicts a character written on a segmented pattern according to the present invention;

FIG. 13b depicts a character written on a segmented pattern according to the present invention;

FIG. 14 depicts two segmented patterns according to the present invention, one segmented pattern for the user to draw the character and the other segmented pattern to display the selected segments to the user;

FIG. 15a depicts a segmented pattern to be used with a camera for inputting information according to the present invention;

FIG. 15b depicts a segmented pattern to be used with a camera for inputting information according to the present invention;

FIG. 15c depicts a segmented pattern to be used with a camera or inputting information according to the present invention;

FIG. 16a depicts a portion of a character written on a segmented pattern and a predicted portion of a character written on a segmented pattern according to the present invention;

FIG. 16b depicts a portion of a character written on a segmented pattern, a predicted portion of a character written on a segmented pattern, and the predicted character displayed according to the present invention;

FIG. 17a depicts one example of an end signal written on a segmented pattern according to the present invention;

FIG. 17b depicts another example of an end signal written on a segmented pattern according to the present invention;

FIG. 17c depicts another example of an end signal written on a segmented pattern according to the present invention;

FIG. 17d depicts a character written on a segmented pattern according to the present invention;

FIG. 17e depicts a character written on a segmented pattern according to the present invention;

FIG. 18 depicts special purpose buttons and a segmented pattern according to the present invention;

FIG. 19 depicts previously matched characters on a segmented pattern while receiving an input for a new character or predicting a character or word;

FIG. 20 depicts predicted matched characters written on the screen while receiving an input for a new character;

FIG. 21 depicts a segmented pattern with some characters displayed on it, used with a keyboard (partially shown), to enter characters not supported by the keyboard;

FIG. 22 depicts a segmented pattern displayed between the keys of a virtual keyboard (the keyboard is partially shown). Some characters are displayed on the segmented pattern;

FIG. 23 depicts a segmented pattern displayed between keys of a virtual keyboard (the keyboard is partially shown). Some characters are displayed on the segmented pattern;

FIG. 24 depicts a segmented pattern displayed between keys of a virtual keyboard (the keyboard is partially shown). Some characters are displayed on the segmented pattern;

FIG. 25 depicts one segmented pattern displayed between keys of a virtual keyboard (the keyboard is partially shown). Some characters are displayed on the segmented patterns;

FIG. 26 depicts two segmented patterns displayed between keys of a virtual keyboard (the keyboard is partially shown). Some characters are displayed on the two segmented patterns;

FIG. 27 depicts two segmented patterns displayed between keys of a virtual keyboard (the keyboard is partially shown). Some characters are displayed on one of the segmented patterns;

FIG. 28 depicts a character table;

FIG. 29 depicts an exception list;

FIG. 30 depicts examples of uppercase and lowercase English characters, numbers and symbols written on the segmented pattern;

FIG. 31 depicts examples of uppercase and lowercase English characters, numbers and symbols written on the segmented pattern;

FIG. 32 depicts examples of uppercase and lowercase English characters, numbers and symbols written on the segmented pattern;

FIG. 33 depicts examples of uppercase and lowercase English characters, numbers and symbols written on the segmented pattern;

FIG. 34 depicts an algorithm for processing strokes written in pseudocode;

FIG. 35 depicts an algorithm for processing segments written in pseudocode;

FIG. 36 depicts a flowchart according to the present invention;

FIG. 37 depicts a computing device according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides a method for inputting data in an electronic device. The electronic device may be, for example, a variety of computing devices capable of presenting data and communicating with a touch screen interface or a touch pad interface. Examples of computing devices include, but are not limited to smart phones, personal data assistants (PDAs), laptops, mobile phones, portable multi media devices, iPhone®, iPad®, surface computing devices and the like.

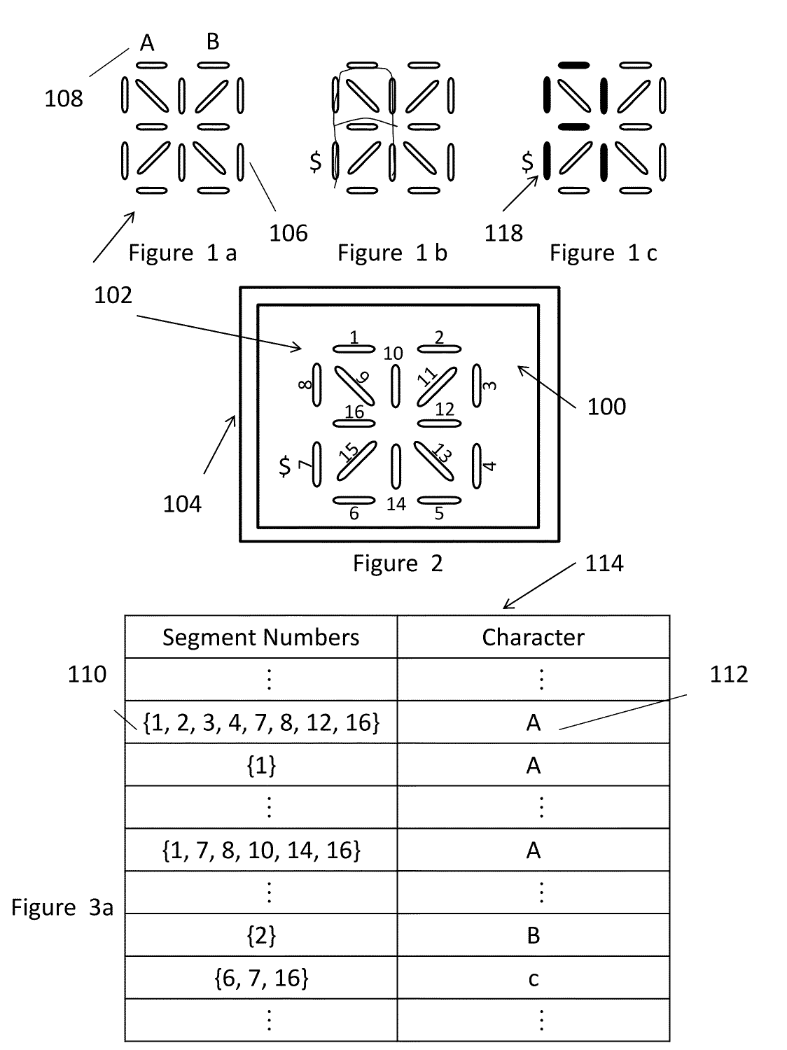

The present invention provides a system for inputting data in an electronic device. As would be appreciated by those of skill in the art, the system may be software performed by a processor of the electronic device. Each step of the present invention that requires steps to be performed would be performed by the processor of the electronic device. The system provides a segmented pattern (102) on a touch sensitive graphical user interface (100) of an electronic device (104), the segmented pattern (102) having at least two segments. The segments may be, by way of example, dots, straight lines or curved lines. A numeric value (e.g. 1, 2, 3, 4, 5, 6, 7, 8, 9, 10, 11, 12, 13, 14, 15, 16) in the electronic device (104) is associated to each of the at least two segments (by way of example 106 in FIG. 1a is one segment). FIGS. 1a, 1b and 1c depict a segmented pattern having sixteen segments, two segments on four sides forming an outside rectangle and eight segments extending substantially from the center of the outside rectangle to a point between each of the two segments on four sides forming an outside rectangle. At least one character is associated to at least one of the segments and is displayed on the segmented pattern (by way of example 108 in FIG. 1a is a character displayed on the segmented pattern and is associated with segment 1). In one embodiment, one or more segments are not lines. In one embodiment, one or more segments are dots or closed circles instead of lines. In one embodiment, the segments do not touch each other. In one embodiment, two or more segments touch each other.

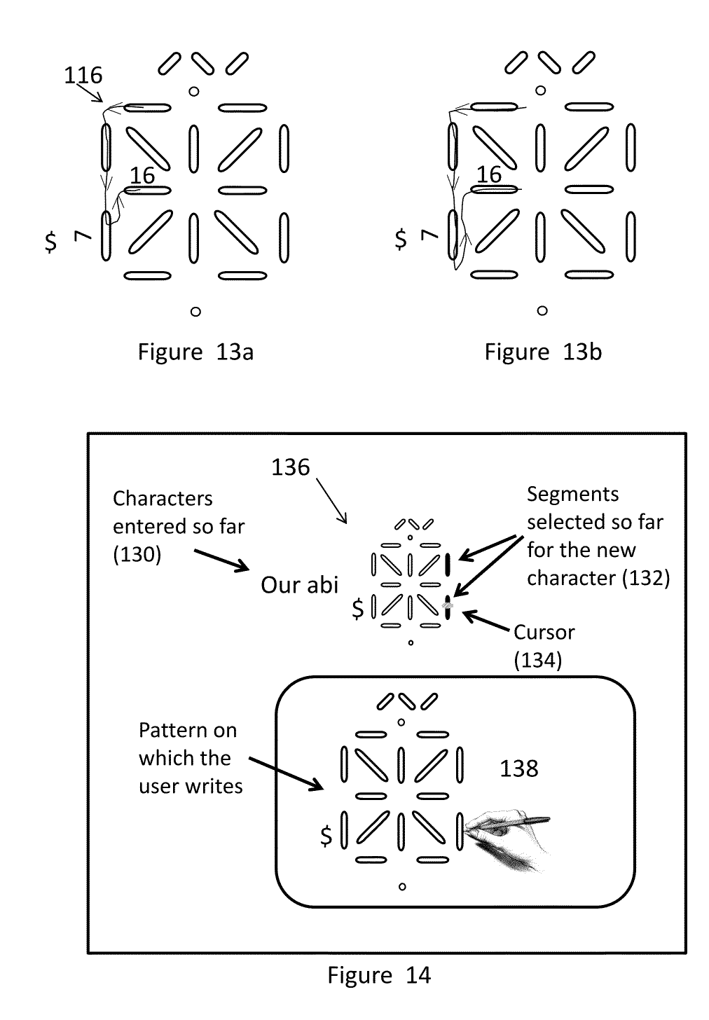

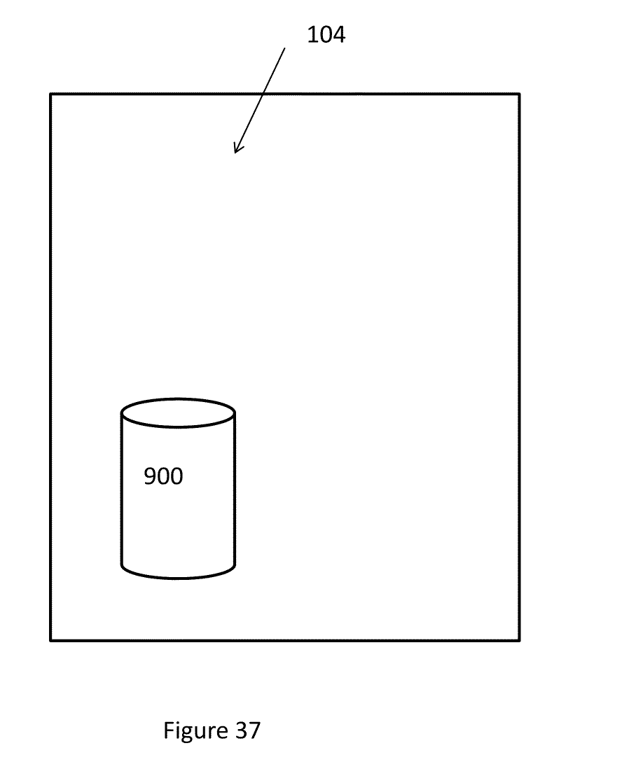

A set of the numeric values are associated to at least one character (112) to provide a corresponding character table (114) stored in the electronic device (104). FIG. 37 depicts a computing device/electronic device (104) with storage (900). An input signal (e.g. 116 of FIG. 13a) (which may by touch input, stylus touch input, video input or any other input means) may be received on at least one segment of the segmented pattern to provide an input having numeric values associated with each of the segments. A sequence of at least one segment (e.g. 110) is determined by the electronic device according to the input having numeric values and the character table. A sequence of at least one segment may also be a single segment. The sequence of the input signals received on at least two segments may end at a point the user has lifted his finger/stylus (i.e. input signals are no longer being received), unless the sequence of inputs received is in an exception list. A matched character is determined by the electronic device according to the input having numeric values, the sequence and the character table, wherein the matched character is displayed on the touch sensitive graphical user interface of an electronic device, stored in the electronic device and the segmented pattern on the touch sensitive graphical user interface of the electronic device is reset. The term “character” can include, by way of example and without limitation, letters, glyphs, numbers, and symbols. In the absence of a matched character, a matched character may be determined by the electronic device according to the input having numeric values, the sequence and the closest character in the character table. The term “closest character” would be the character that has the closest match to the input having numeric values and the sequence. So, for example, if the input having numeric values (or segment numbers) is (1, 3, 4, 7, 8, 11, 12 and 16) entered (or input) in the sequence (7, 8, 1, 11, 4, 16 and 12) and we know that an “A” is typically (1, 2, 3, 4, 7, 8, 12 and 16) and a “c” is typically (6, 7, and 16), the closest character is an A, even though it is not a direct match. Accordingly, the matched character is provided as the closest character in the character table. The sequence of the input signals received on the at least two segments may be the shortest possible sequence. The electronic device may backtrack and change the sequence chosen from input signals received at least one segment based on the results of matched characters (or unmatched characters) determined according to the input having numeric values and the character table. The displayed characters on the segmented pattern allow faster data entry (by way of example in FIG. 1a, “A” is associated with segment 1 and “B” is associated with segment 2. A user can quickly enter “A” by dragging her finger on segment 1. Similarly, she can enter “B” by dragging her finger on the segment to which “B” is associated (the segment close to “B”)). Additionally, the displayed characters on the segmented pattern allow a user who is not familiar with the way characters must be drawn on the segmented pattern, to easily use the system,

FIG. 1c depicts an indicator (118) of the input signal. In this example, the indicator is a darker color on the segmented pattern as in an indicator of the input signal displaying activated segments according to the input signal received on at least one segment.

FIG. 1a shows a segmented pattern which can be used for receiving an input signal on at least one segment of the segmented pattern to provide an input having numeric values associated with each of the segments (inputting characters) such as English characters. The user writes with his finger or stylus on the graphical user interface (touch screen) and touches the segments of the pattern displayed on the touch screen (receiving an input signal on at least one segment of the segmented pattern to provide an input having numeric values associated with each of the segments). After touching each segment (i.e., selecting the segment or receiving an input signal on at least one segment of the segmented pattern to provide an input having numeric values associated with each of the segments), the color of the segment may be changed. It may be a different color or merely bolded, providing an indicator of the input signal. By touching the appropriate segments, the user can write a character such as “A”. FIG. 1b shows character “A” written on the pattern. In FIG. 1c, the hand drawn character has been converted into a character written using segments. Alternatively, instead of showing a line drawn by the user, segments may be selected or activated (i.e., their color changed) when the user touches them (i.e., FIG. 1c is directly generated). In FIGS. 1a and 1b, a single character (i.e., “$”) is displayed on the segmented pattern. Thus, “$” can be entered easily by tapping on its corresponding segment.

There is the step of associating a numeric value in the electronic device to each of the at least two segments. FIG. 2 shows a number, or numeric value, associated with each of the sixteen segments. Thus, there will be a set of numbers (e.g. 110) corresponding with the segments that have received an input control (e.g. have been touched). After touching a set of segments, the user may signal to the electronic device (more specifically the processor of the electronic device) that he has finished entering the character/symbol (the way the user can signal will be discussed later) or the system/method/device, based on some information, decides writing the character is finished.

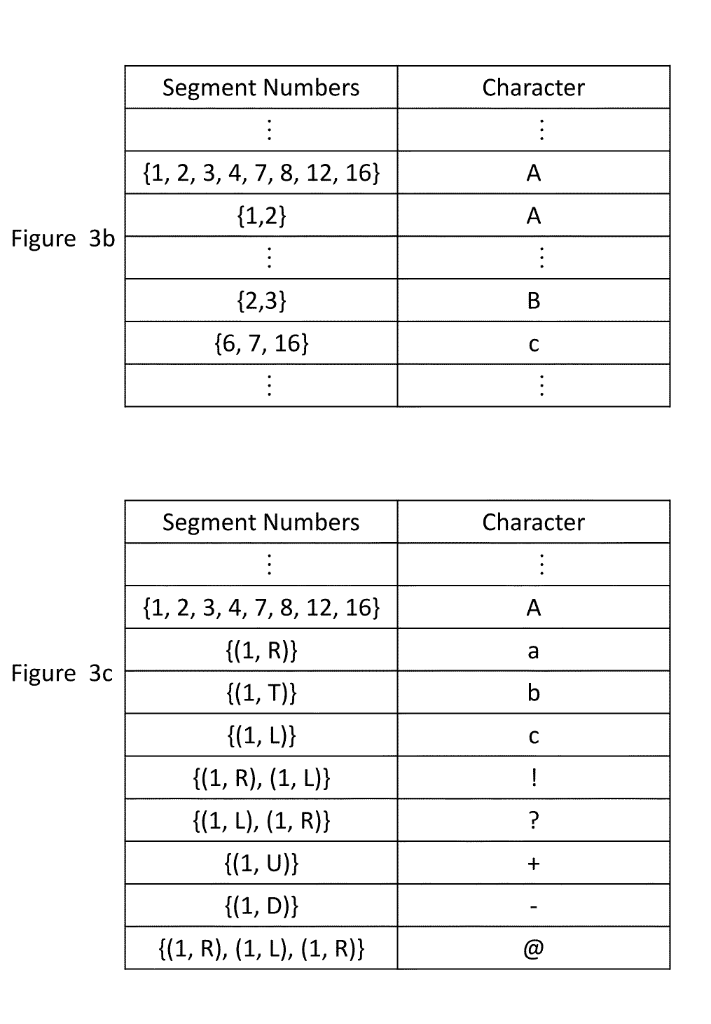

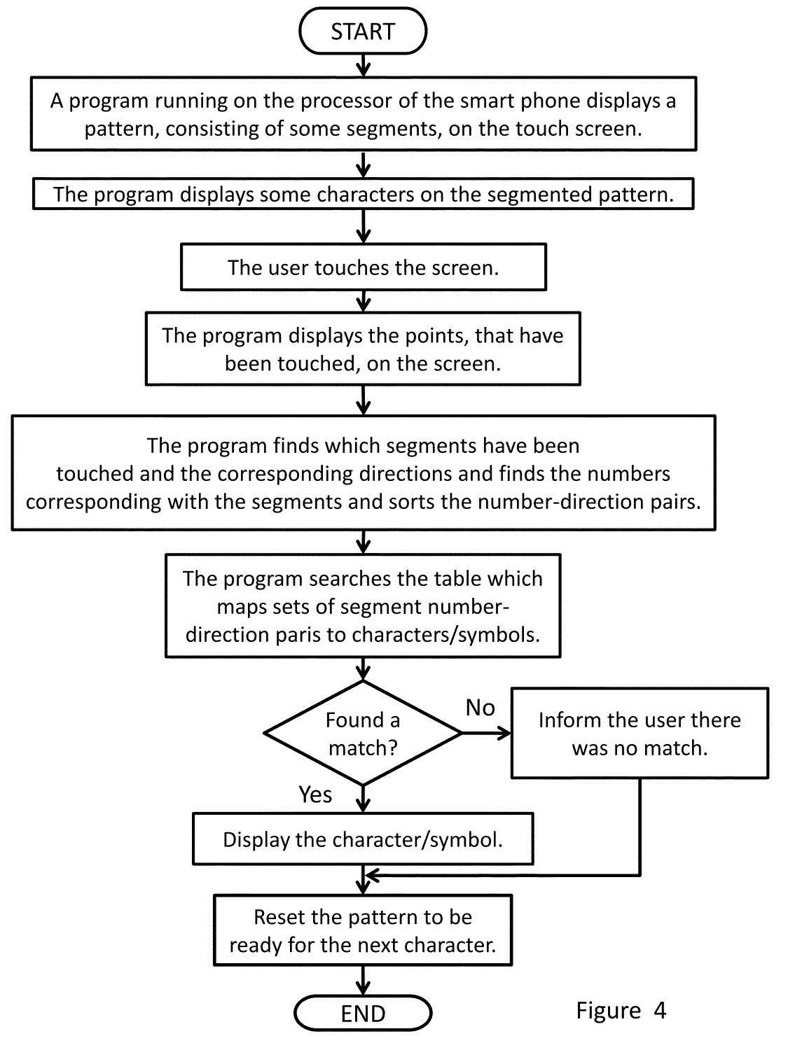

The electronic device (more specifically the processor of the electronic device) sorts the numbers, which are associated with the selected segments. There is a corresponding character table with prewritten entries. Each table entry includes a set of numbers and the code (e.g., ASCII code) for the corresponding character/symbol as depicted in FIG. 3a. As shown in FIG. 3a, the letter A may receive input signals on segments (as shown in FIG. 2) having numeric values of (1,2,3,4,7,8,12,16) or (1,7,8,10,14,16). The electronic device would determine that A is the matched character according to the input on the segments (1,7,8,10,14,16) and the table indicating that the presence of those number indicates a matched character. The letter c may be determined as a matched character according to the input on segments (6,7,16) and the table indicating that the presence of those number indicates a matched character. The processor searches the table to see if the set of numbers exist in the table. If the set exists, then the matched character (the term character includes symbols, etc.) is displayed on the screen; otherwise, there is no character corresponding with the set of segments touched. The processor can inform the user by displaying an error message or symbol, beeping, etc. Next, the segmented pattern is reset and the processor gets ready to receive the next character (FIG. 4). In one embodiment, the processor searches the table for a match without sorting the numbers. In one embodiment, for each segment that has received an input control (e.g. has been touched), in addition to the segment number, there is a direction corresponding to the direction of the input control received on the segment. Thus, there is a set of number-direction pair corresponding to the input. Direction can for example be selected from the set of {right, left, up, down}. As an example, direction “right” means dragging finger on a segment from left to right. Additionally, the direction set may be extended to include tapping. These may be denoted by R, L, U, D and T. One or more of the entries in the character table may have direction information in addition to the segment numbers. The processor will first search the table to find a match for the set of number-direction pairs entered by the user. If there is a match the corresponding character is printed on the screen. Otherwise, the processor may search the table to find an entry such that only its segment numbers match the segment numbers corresponding to the user input (i.e., the direction information for the user input is ignored). In one embodiment, the processor sorts table entries and the user input, based on the segment numbers and then based on the directions before searching the table for a match. FIG. 3c shows an example of the character table which has direction information for some entries. As an example, if the user drags his finger on segment 1 from left to right, the corresponding number-direction pair will be (1, R) and its corresponding character in the table is “a”. As another example, if the user drags his finger on segment 1 from left to right and then from right to left, the set {(1, R), (1, L)} corresponds to the user input and “!” is the corresponding character.

In one embodiment, instead of having a set of numbers or a set of number-direction pairs for each character table entry or for the user input, there is an array of numbers or an array of number-direction pairs (i.e., repetition is allowed). For example, a user may drag her finger on segment 1 from left to right, then from right to left, and finally from left to right without lifting her finger from the touch screen in between. The user input will be {(1, R), (1, L), (1, R)} in this case and will correspond to character “@”.

In one embodiment, the set of numbers corresponding to the user input or the character table entry can have an indicator (e.g., 0) to denote lifting the finger from the screen in between touching the segments. For example, {1, 0, 2} will correspond to touching segment 1, lifting the finger from the screen, and then touching segment 2. In one embodiment, the array of numbers corresponding to the user input or the character table entry can have an indicator (e.g., 0) to denote lifting the finger from the screen in between touching the segments. In one embodiment, the set of number-direction pairs corresponding to the user input or the character table entry may have an indicator (e.g., ( )) to denote lifting the finger from the screen in between touching the segments. For example, {(1, R), 0, (1, L)} corresponds to dragging finger on segment 1 from left to right, lifting the finger from the screen, and then dragging finger on segment 1 from right to left. In one embodiment, the array of numbers corresponding to the user input or the character table entry can have an indicator (e.g., ( )) to denote lifting the finger from the screen in between touching the segments.

FIG. 3b shows another character table. In this case, “A” can be entered for example by touching segments 1 and 2.

Some advantages of the proposed invention are that it can easily support many languages, arithmetic symbols, and numbers, it does not require a complex algorithm with long execution time to detect the entered characters, symbols, or numbers, thus, the detection (recognition) can be done in real time and without significant latency. The short execution time of the present invention translates into lower energy consumption for the processor running the method, which is very important in portable devices. Additionally, some characters are displayed on the segmented pattern and can be entered by for example, tapping on one segment or dragging a finger on a single segment. This allows faster entry of the displayed character. For example, in FIG. 1a, character “A” can be entered by tapping on segment 1. This is much faster than touching segments 1, 2, 3, 4, 7, 8, 12, 16 to write “A”. The present invention can support many more characters than a typical virtual keyboard does, while using a smaller portion of the touch screen. Generally characters and symbols are required to be written the way they look, thus, memorizing a new alphabet/character set is not necessary. Because of the simplicity and its nature, its error rate is zero, if the user has touched the right segments. Thus, there will be no error when entering characters/symbols if the user's error rate is zero.

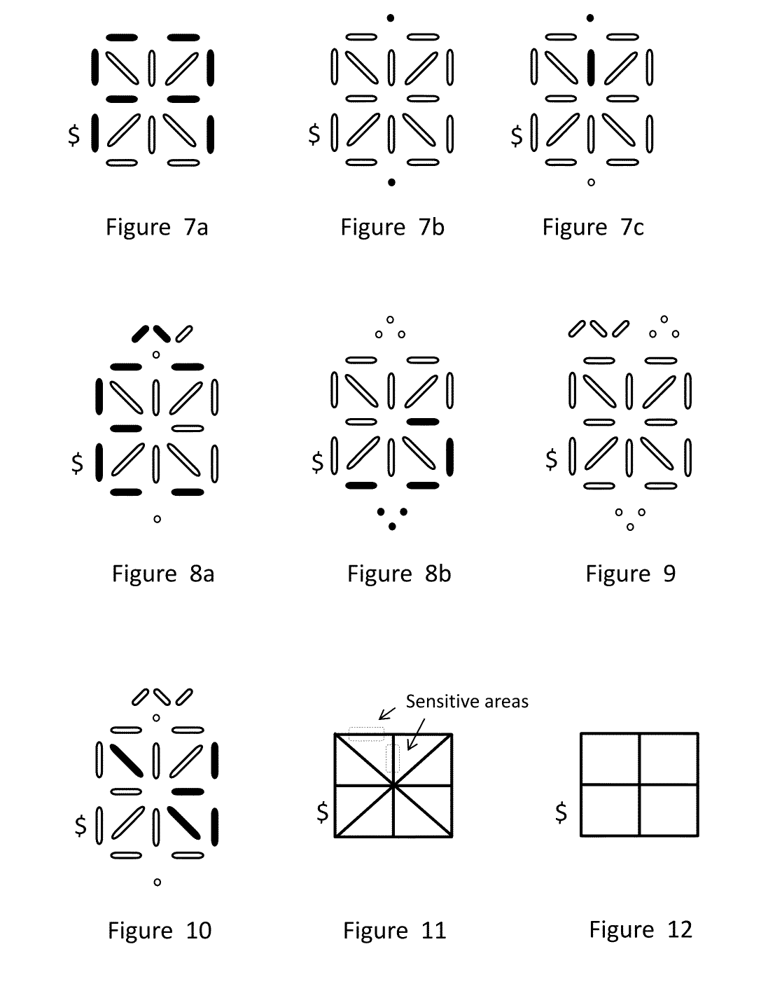

There might be more than one set of numeric values (for segments) associated with each character. For example, FIGS. 1c and 7a show two ways that character “A” can be written.

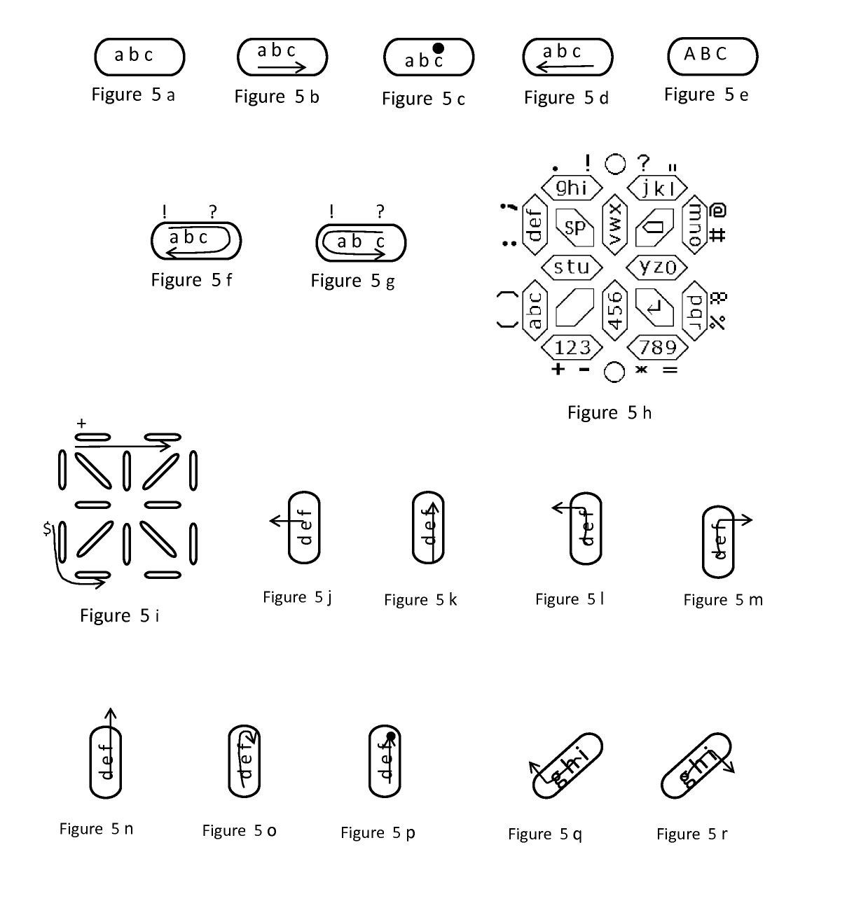

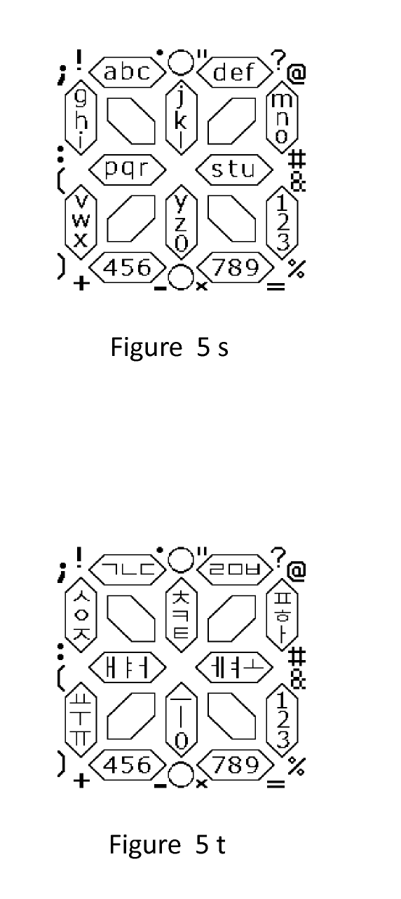

In one embodiment, to increase the speed of data entry and to decrease the learning curve, one or more characters or symbols may be assigned to some of the segments, and the characters or symbols may be entered by tapping and/or touching the said segment (fast entry method). For example, in FIG. 5a, three characters “a”, “b”, and “c” have been assigned to a segment. The user can enter character “a” by dragging his finger on the segment from left to right (i.e., putting his finger on the side of the segment where character “a” has been displayed and moving his finger towards the other side of the segment) (see FIG. 5b). Character “b” can be entered by tapping on the segment (FIG. 5c) and character “c” can be entered by touching the segment starting from right (the side where character “c” has been displayed) and moving the finger towards left (FIG. 5d). Note that for a vertical or a diagonal segment, the finger is moved vertically or diagonally from one side of the segment to the other side, respectively. Since the characters are displayed on the segment, even a user with no prior experience with the system/method/device can quickly find the characters and enter them if he knows the above simple rules. FIG. 5h and FIG. 5s show all English letters a-z, digits 0-9, and some punctuation displayed on the pattern.

FIG. 5t shows some Korean characters, digits 0-9, and some punctuation displayed on the pattern.

In one embodiment, uppercase letters are displayed and entered instead of lowercase letters (FIG. 5e). In one embodiment, both uppercase and lowercase letters are displayed on the segments of a pattern and can be entered. In one embodiment, one or more of symbols, special characters, or punctuations may be displayed on some segments of the pattern. In one embodiment, one or more characters from one or more languages may be displayed on some segments of the pattern and can be entered. In one embodiment, a character is entered if the user puts his finger on the first side of a segment and moves his finger to the other side of the segment and continues the movement in the reverse direction until his finger reaches to the first side. FIG. 5f shows how “!” can be entered in this way, while FIG. 5g shows how “?” can be entered in this way. In one embodiment, the characters that can be entered by dragging a finger on a segment in one direction and then in the reverse direction on the same segment, may be written next to the segment and outside the pattern (FIG. 5h). In one embodiment, the characters are written outside the pattern with a color different than the color of the first set of characters (i.e., the characters written inside the segments). In one embodiment, letters “a-z” and digits 0-9 are written inside the segments and are entered by tapping on the segments or dragging a finger on the segments, while punctuations are written outside the segments and are entered by two consecutive finger dragging in opposite directions, on the same segment and without lifting the finger between the consecutive finger dragging (FIG. 5h).

In one embodiment, a set of characters may be entered by dragging a finger on two or more consecutive segments of the pattern (FIG. 5i).

In one embodiment, tapping on some segments or dragging a finger on some segments in a particular direction or independent of the direction, can move the cursor in the text area to the right, the left, the previous line or the next line. In one embodiment, if the cursor is at the end of the text, moving the cursor to the right inserts a space.

In one embodiment, a spell checker is used to find the spelling and grammatical errors. In one embodiment, when there is a spelling error a sound is played. In one embodiment, when there is a spelling error the device (e.g., smart phone or smart watch) vibrates. In one embodiment, tapping on a segment or touching it in a particular direction can be used to navigate through spelling or grammatical errors. In one embodiment, tapping on a segment or touching it in a particular direction moves the cursor to the position right after the last spelling error (i.e., the n-th error if there are n errors in the text). In one embodiment, tapping on a segment or touching it in a particular direction moves the cursor to the position right before the last spelling error. In one embodiment, when the cursor moves to the error position, the erroneous word is selected (thus, if the user enters a word, the new word replaces the erroneous word). In one embodiment, pressing the segment for the i-th time, moves the cursor to the position of the (n−i+1)-th error (n is the number of errors in the text and i<=n). If there is no error, the cursor doesn't move. In one embodiment, pressing the segment for the i-th time moves the cursor to the position of the i-th error (n is the number of errors in the text and i<=n). If there is no error, the cursor doesn't move. In one embodiment, when the cursor moves to the error position, an enumerated list of suggested words is displayed and entering a number by using the pattern will result in selecting the word associated with that number from the list and replacing the erroneous word with the selected word.

In one embodiment, in addition to a simple finger movement (tapping, dragging a finger from one side of the segment to the other side, dragging a finger from one side of the segment to the other side and moving the finger again in the reverse direction to reach the initial side), the user may perform a gesture at the end of the movement. For example, the user may drag his finger, for a short distance (e.g., a quarter of the length of the segment), upward, downward, continue moving his finger in the direction of the segment and touch the outside of the segment, move his finger in the reverse direction, or hold his finger on the touch screen, without moving his finger, for a short period of time (e.g., 200 ms) before lifting his finger, or doing nothing (just lifting his finger when the simple movement ends). Different movements when a segment is placed horizontally are: Tap, Left to right, Left to right to left, Right to left, and Right to left to right. Different end gestures when a segment is placed horizontally are: Nothing, Move upward (left for vertical segments), Move downward (right for vertical segments), Move in reverse direction, Move in the same direction, Hold finger on the screen. FIG. 5j shows how the end gesture of moving the finger slightly towards left can be combined with tapping on the segment. In this case, it will be equivalent to dragging the finger from right to left. FIG. 5k shows how a simple upward dragging can be performed. FIGS. 5l and 5m show how the end gesture of moving the finger slightly towards left and right can be performed after a simple dragging. FIGS. 5n and 5o show how the end gesture of moving the finger slightly outside the segment by continuing the movement in the same direction, and the end gesture of moving the finger in the reverse direction can be performed. FIG. 5p shows how the finger can be kept on the touch screen after performing a simple drag.

Depending on how a user ends the gesture, a different character may be entered into the system/method/device. For example, the end gesture of moving upward (or left for vertical segments), may be used to enter an uppercase character. For example, in FIG. 5q, the user enters “I”. Note for the end gesture, the finger moves for a short distance (e.g., a quarter of the length of a segment), while when touching a segment, the finger must move for a longer distance (e.g., longer than half of the length of a segment).

The average length of an English word is 5 letters. Thus, roughly after every five characters, a user may enter one space. An easy way to enter a space after entering a word can substantially increase the text entry speed. In one embodiment, the end gesture of moving downward (or right for vertical segments), can be used to enter a space after the character is written. For example in FIG. 5r, the user writes “g” (i.e., “g” followed by a space).
In one embodiment, the end gestures can be performed after dragging finger on two or more segments.

In one embodiment, some of the characters, not all of the characters, that can be entered are shown on the pattern. For example, instead of displaying “a b c” on a segment, only one of them “a” is displayed. In one embodiment, the order of characters displayed may be changed. For example, “c b a” may be displayed on a horizontal segment. In this case, to enter “a” the finger can be dragged from left to right (i.e., the move finishes on the side of the segment where “a” has been written).

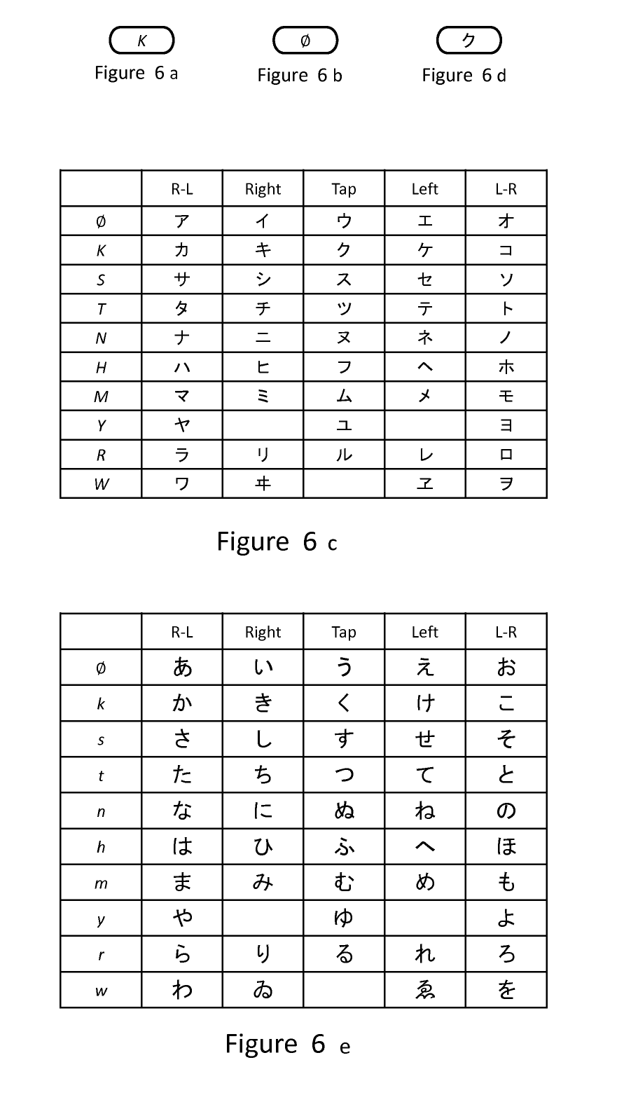

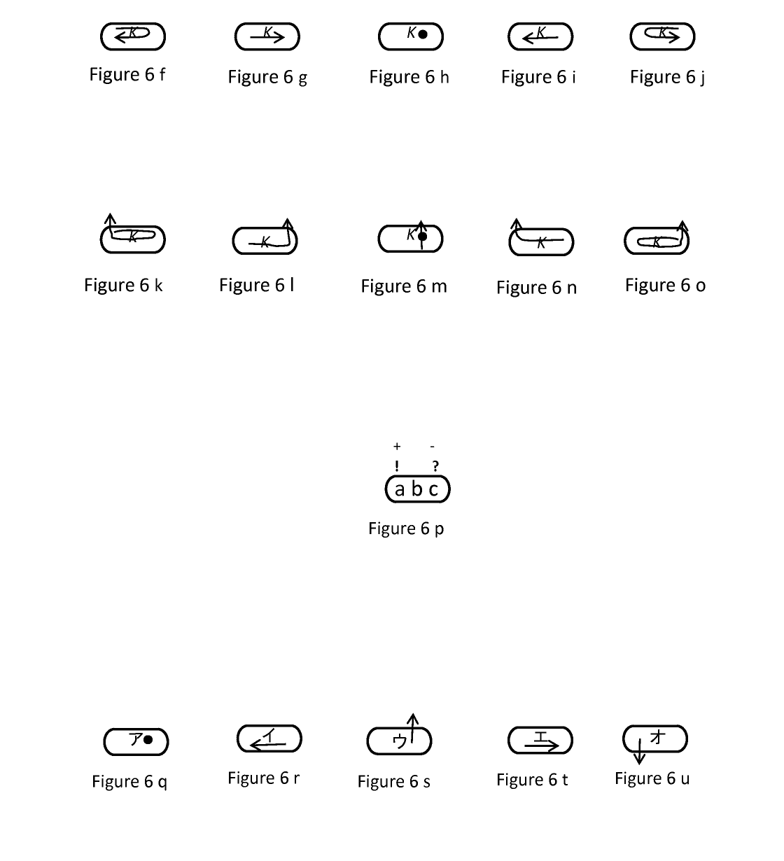

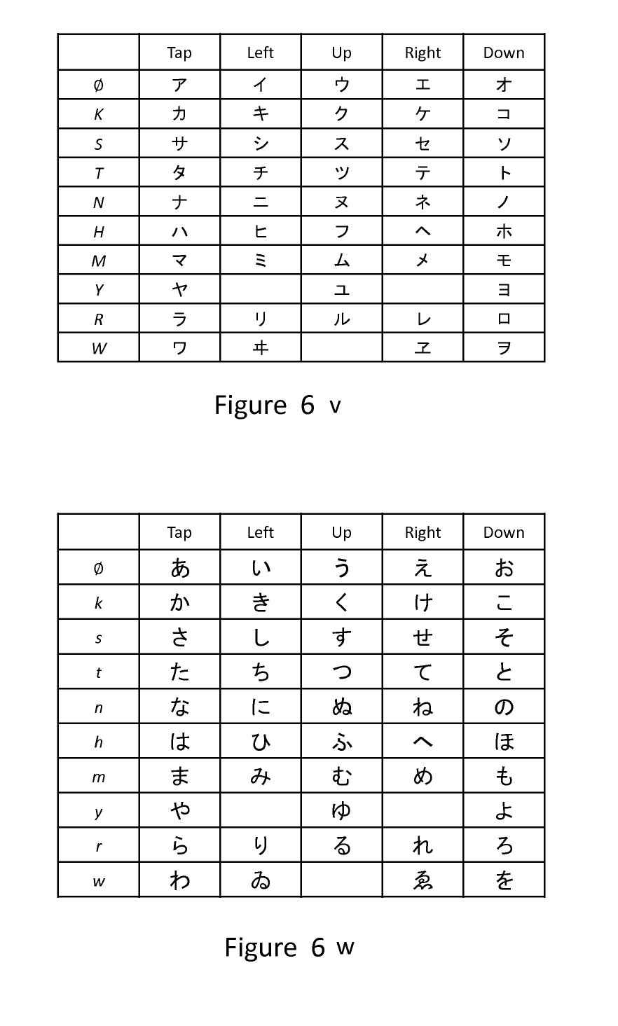

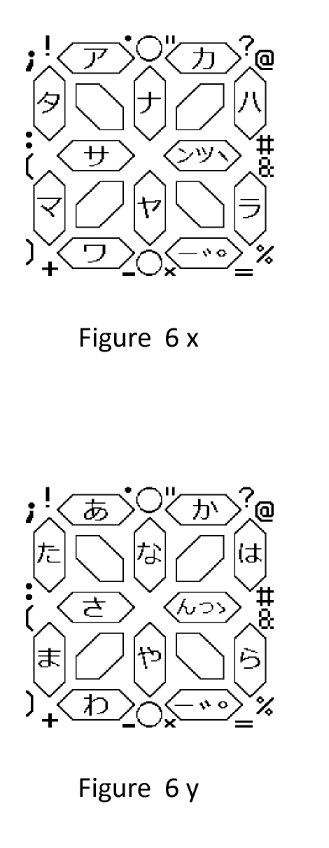

In one embodiment, each of the 9 consonants used in the Japanese Katakana syllabary is assigned to a single segment (FIG. 6a). Depending on the movement of the finger, one of the consonant-vowel combinations can be entered. One segment may be denoted by “Ø” and may be used to enter vowels “a”, “i”, “u”, “e”, and “o” (FIG. 6b). The remaining Katakana characters and diacritics may be assigned to other segments. Furthermore, if a combination of a consonant and a vowel is not valid, the corresponding segment with the corresponding gesture may be used to enter another character or nothing might be assigned to it. In FIG. 6c, R-L, Right, Left, and L-R denote dragging a finger from left to right and then in the reverse direction towards left, dragging a finger from left to right, dragging a finger from right to left, and dragging a finger from right to left and then in the reverse direction towards right, respectively. In one embodiment, for a vertical segment, the movements will be denoted by U-D, Up, Down, and D-U, where D stands for down and U stands for up. In one embodiment, instead of displaying the consonant on the segment, one or more of the Japanese Katakana characters are displayed (FIG. 6d).

In one embodiment, each of the 9 consonants used in the Japanese Hiragana syllabary is assigned to a single segment. Depending on the movement of the finger, one of the consonant-vowel combinations can be entered. One segment may be denoted by “Ø” and may be used to enter vowels “a”, “i”, “u”, “e”, and “o”. The remaining Hiragana characters and diacritics may be assigned to other segments. Furthermore, if a combination of a consonant and a vowel is not valid, the corresponding segment with the corresponding gesture may be used to enter another character or nothing might be assigned to it. In FIG. 6e, R-L, Right, Left, and L-R, denote dragging a finger from left to right and then in the reverse direction towards left, dragging a finger from left to right, dragging a finger from right to left, and dragging a finger from right to left and then in the reverse direction towards right, respectively. In one embodiment, for a vertical segment, the movements will be denoted by U-D, Up, Down, and D-U, where D stands for down and U stands for up. In one embodiment, instead of displaying the consonant on the segment, one or more of the Japanese Hiragana characters are displayed.

In one embodiment, each of the 9 consonants used in the Japanese Katakana and Hiragana syllabaries is assigned to a single segment. Depending on the movement of the finger and the end gesture or the lack of the end gesture, one of the consonant-vowel combinations can be entered. One segment may be denoted by “Ø” and may be used to enter vowels “a”, “i”, “u”, “e”, and “o”. The remaining characters and diacritics may be assigned to other segments. Furthermore, if a combination of a consonant and a vowel is not valid, the corresponding segment with the corresponding gesture may be used to enter another character or nothing might be assigned to it. For example, for a horizontal segment, Katakana characters may be entered by simple tap, R-L, Right, Left, and L-R movements, while Hiragana characters may be entered by simple tap, R-L, Right, Left, and L-R movements followed by a short upward drag of the finger on the touch screen. FIGS. 6f-6j show how Katakana characters) [symbol] , [symbol] , [symbol] , [symbol] , [symbol] can be entered, respectively. FIGS. 6k-6o show how Hiragana characters [symbol] , [symbol] , [symbol] , [symbol] , [symbol] can be entered, respectively.

In one embodiment, each of the Japanese Katakana characters [symbol] , [symbol] , [symbol] , [symbol] , [symbol] , [symbol] , [symbol] , [symbol] , [symbol] , and [symbol] is assigned to a single segment and is entered by tapping on its corresponding segment (FIG. 6q shows [symbol] assigned to a segment and FIG. 6x shows all 10 characters displayed on the segmented pattern). These characters correspond to the second column in the table of FIG. 6v. Each row in the table corresponds to one consonant or “Ø” and each column corresponds to one of the vowels “a”, “i”, “u”, “e”, and “o”.

Depending on the direction of the movement of the finger on each segment, one of the other characters in the row corresponding to the displayed character may be entered. For example, FIG. 6r shows that by dragging the finger on the segment from the right to the left, character [symbol] is entered. FIG. 6s shows that by dragging the finger on the segment from the bottom to the top, character [symbol] , is entered. FIG. 6t shows that by dragging the finger on the segment from the left to the right, character [symbol] is entered. FIG. 6u shows that by dragging the finger on the segment from the top to the bottom, character [symbol] is entered. The remaining characters and diacritics such as dakuten and handakuten may be assigned to other segments and entered by tapping on a segment or dragging finger on the segment.

In one embodiment, each of the Japanese Hiragana characters [symbol] , [symbol] , [symbol] , [symbol] , [symbol] , [symbol] , [symbol] , [symbol] , [symbol] , and [symbol] is assigned to a single segment and is entered by tapping on its corresponding segment (FIG. 6y shows all 10 characters displayed on the segmented pattern). These characters correspond to the second column in the table of FIG. 6w. Each row in the table corresponds to one consonant or “Ø” and each column corresponds to one of the vowels “a”, “i”, “u”, “e”, and “o”. Depending on the direction of the movement of the finger on each segment, one of the other characters in the row corresponding to the displayed character is entered. The remaining characters and diacritics such as dakuten and handakuten may be assigned to other segments and entered by tapping on a segment or dragging finger on the segment.

In one embodiment, to each of one or more types of end gestures, a short sound is associated. The short sound is played to provide a feedback to the user, each time the user uses that particular gesture ending.

In one embodiment, one or more of the characters that can be entered, may not be displayed on the pattern to make the pattern less cluttered. In one embodiment, punctuations are written outside the segments. In one embodiment, three sets of characters or symbols are displayed on a segment and entered by tapping or dragging a finger on one or two segments (FIG. 6p). The third set of characters (i.e., “+” and “−” may be entered by for example dragging a finger on two segments clockwise as depicted in FIG. 5i. In one embodiment the third set of characters may be entered by dragging a finger on a single segment and adding an ending gesture.

In one embodiment, when a button is pressed, a segment is tapped, or one or more segments are touched in a particular order or in a particular direction, the mode of the operation is changed. This can be used for example to change the language and enter characters in more than one language. This can also be used to enter special characters, punctuations, and math symbols. In one embodiment, when the mode changes the new characters that can be entered are displayed on the segments or around them.

In one embodiment, some characters, for which, there is no fast way of entering (i.e., the characters that are not displayed on the segmented pattern), can be entered by drawing them on the segmented pattern. In one embodiment, some characters, for which, there is a fast way of entering (i.e., the characters that are displayed on the segmented pattern), can also be entered by drawing them on the segmented pattern. In one embodiment, the user input (i.e., the points touched by the user) is checked to see if they correspond to a valid input entered using the fast method. If they don't, then the user input is passed to the algorithm which detects a character written on the segmented pattern.

In one embodiment, when a button is pressed, a segment is tapped, or one or more segments are touched in a particular order or direction, a list of characters is displayed. The list can be used to select and enter a character. This can be used for example to enter characters which are not supported by the fast entry method. In one embodiment, when a character is selected, the way the character can be written on the segments of the pattern is displayed to teach the user how to quickly enter the character next time without using the list.

In one embodiment, instead of associating a single character, a sequence of characters are associated with a single segment or a set of segments. For example, by dragging a finger from left to right on segments 1 and 2, “ed” may be entered. In one embodiment, the sequence is selected from the list of most common digraphs (two-letter sequences). In one embodiment, the sequence is selected from the list of most common trigraphs (three-letter sequences).

In one embodiment, the sequence is a word (e.g., “the”). In one embodiment, the sequence is a word and a space is automatically inserted after the word is entered (e.g., “the”).

In one embodiment, short cuts may be used to enter words or expressions. For example, when the user writes the word btw, it is automatically expanded to “by the way”. In one embodiment, pressing the backspace after a shortcut is expanded, will undo the expansion.

In one embodiment, tapping on a segment or dragging a finger on one or more segments in a particular direction can be used to enter a space, backspace, or enter.

In one embodiment, the characters of one language are entered using the fast method (i.e., they are displayed on the pattern) and the characters of a second language are entered by writing them on the segmented pattern.

In one embodiment, instead of segments, keys are displayed. In one embodiment, the keys are the keys of a keyboard. In one embodiment, the user can change the character about to be entered, from lowercase to uppercase or vice versa by performing an end gesture (e.g., dragging up a finger on the screen). In one embodiment, when entering a character, the user can enter a space after it, by performing an end gesture (e.g., dragging up a finger on the screen).

In one embodiment, the segmented pattern, with some characters displayed on it, is used in conjunction with a physical or a virtual keyboard. The segmented pattern may be used to enter characters not supported by the keyboard or to enter characters in a different language. In one embodiment, the segmented pattern is displayed on a virtual keyboard. In one embodiment, the segmented pattern is displayed between keys of a virtual keyboard. In one embodiment, the fast entry method is used to enter some of the characters or symbols (i.e., some characters are displayed on the segmented pattern and can be entered for example, by tapping on a single segment or dragging finger in a particular direction on a single segment). In one embodiment, the segments can't be tapped, the user can only drag his finger on the segments to enter characters. In one embodiment, the segmented pattern is used to enter characters in a language different than the keyboard language. In one embodiment, the segmented pattern is used to enter punctuations, numbers, math symbols or special characters. In one embodiment, the segmented pattern is used to control the cursor. In one embodiment, the segmented pattern is used to navigate through the spelling and grammar errors.

In one embodiment, the characters corresponding to a segment can be entered based on the number of taps on the segment. For example, “a”, “b”, and “c” are associated to a single segment and are displayed on the segment.

“c” can be entered by tapping on the segment three times within a given period of time and without touching any other segment in between. “b” can be entered by tapping on the segment twice within a given period of time and without touching any other segment in between. “a” can be entered by tapping on the segment once. In this case, the character table will have arrays of numbers instead of sets of numbers (i.e., a number may appear more than once in a set). Similarly, instead of a set of segments touched by the user, there will be an array of segments touched by the user (i.e., some segments may be touched more than once).

In one embodiment, the user taps on a segment once to enter any of the corresponding characters to that segment. For example, assuming “a”, “b”, and “c” are written on a segment, to enter any of “a”, “b”, or “c”, the segment is tapped once. This creates ambiguity. For example, assuming 3 characters correspond to each segment of the pattern, if the user taps 4 times on segments to enter a 4-letter word, it will not be clear which of the 3*3*3*3=81 possibilities the user intended to enter. Not all 81 possibilities correspond to a valid word. Disambiguation is achieved by searching through a dictionary to find out which of the 81 possibilities correspond to a valid word and showing a list of valid words to the user. The user can select the word he/she intended to enter by tapping on a word in the list. In one embodiment, the statistical information of words are used to select a set of words with the highest occurrence frequency to add to the list. In one embodiment, the statistical information of words is used to sort the words in the list based on their occurrence frequencies.

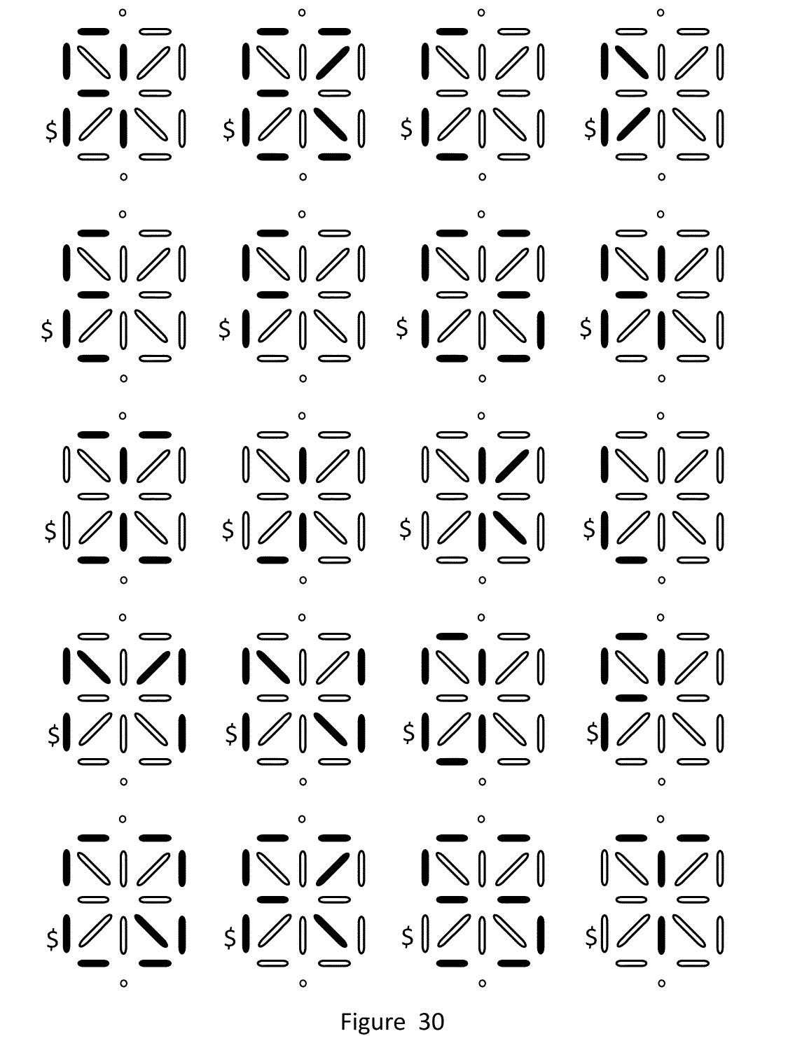

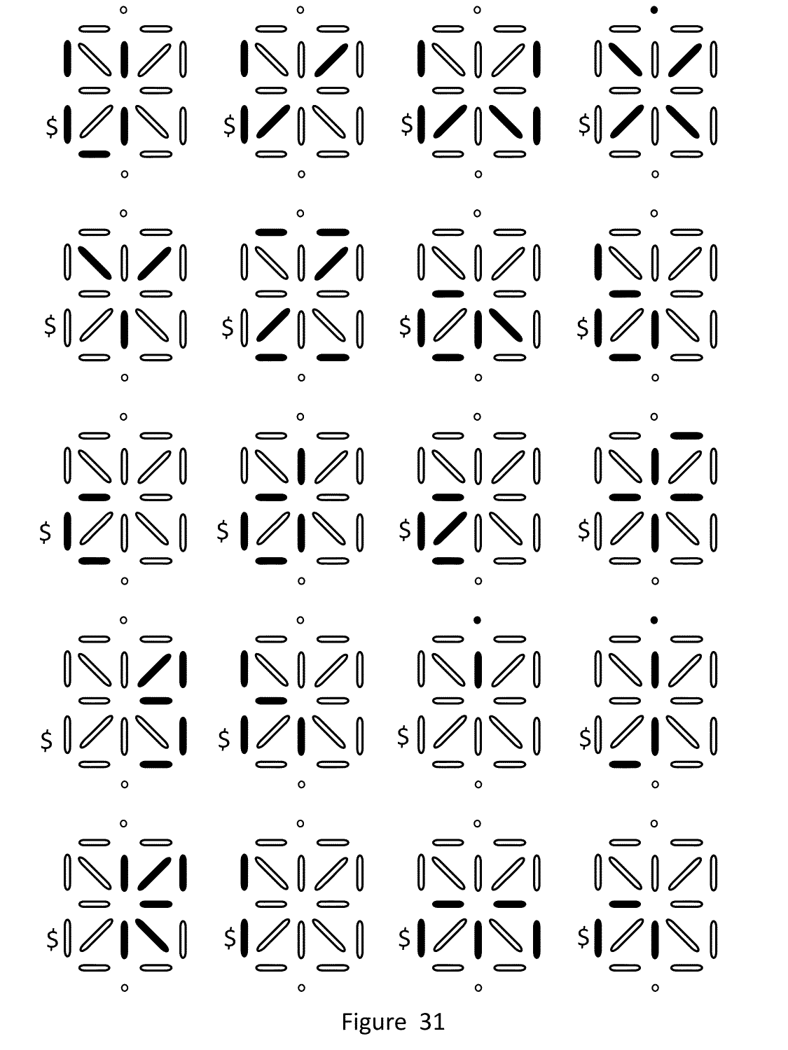

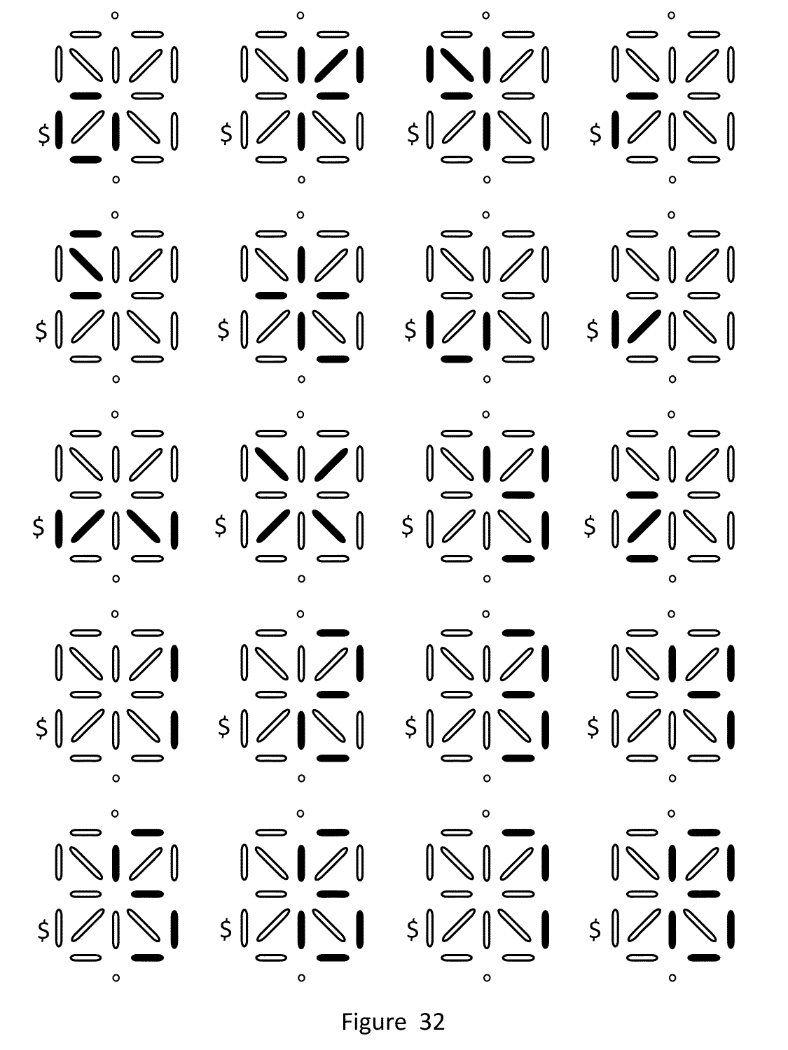

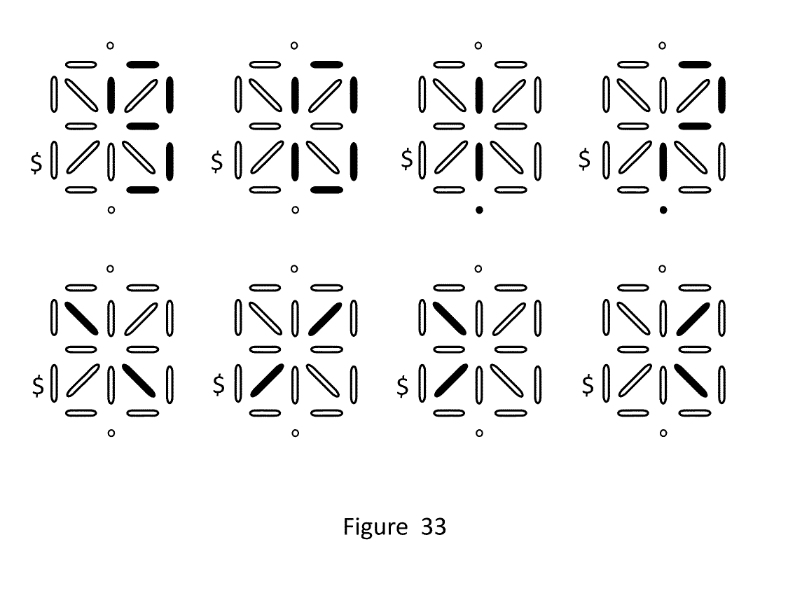

It is possible to use a different number of segments or different shapes for segments in the pattern. In particular, extra segments may be added to support additional symbols, other languages, etc. FIG. 7b shows an extended version of the pattern on which “:” has been written, while FIG. 7c shows the pattern on which “i” has been written. FIGS. 30-33 show how uppercase and lowercase English characters, numbers and some symbols can be written on the segmented pattern.

FIG. 8a shows another version, which can handle diacritics common in languages such as French. In the figure, character “Ê” has been written on the pattern. FIG. 8b shows yet another version appropriate for Farsi and Arabic languages. It is noteworthy that the above patterns can be combined to create a segmented pattern which can be used for several languages (see FIG. 9). Arithmetic symbols can be easily written using the described invention. FIG. 10 shows symbol for “for all” operator. While in the previous patterns, the segments do not touch each other, it is possible to have a pattern in which the segments touch each other. This can make the pattern look better and simpler (FIG. 11). In this case, the sensitive area of each segment can be smaller than its visible part. Thus, a segment can be selected if its sensitive area is touched. Furthermore, to reduce the chance of accidentally touching/selecting/receiving an input signal for a segment, the processor may assume the user has selected the segment if the user touches the segment for longer than a predefined threshold. In one embodiment, the threshold can be changed by the user or dynamically by the system/method/device based on the user's behavior. In one embodiment, some parts of a pattern are drawn, while other parts are not displayed to prevent cluttering the pattern (FIG. 12). FIG. 12 depicts a segmented pattern having sixteen segments, but only twelve segments have been shown, two segments on each of four sides forming an outside rectangle and four segments extending from the center of the outside rectangle to the outside rectangle. In other words, there are sixteen segments that are sensitive to touch, but only twelve segments are displayed to the user. In one embodiment, when invisible segments are touched and selected, they become visible and change color.

In one embodiment, the user draws a line on the screen and the line is displayed and is later processed by the processor and the segments touching the lines or the segments close to the lines are selected. In one embodiment, the user touches the screen and the touch points are displayed and are later processed by the processor and the segments touched or close to the touched points are selected. In one embodiment, instead of displaying a line, the color and/or the style of one or more segments are changed. This provides an instant feedback to the user on what segments the processor considers to be selected. In addition to increasing the usability, this also helps the user to increase the speed of entering characters. For example, to write character “F”, the user can move his finger as shown in FIG. 13a. Because of the instant feedback, the user sees that the processor considers segments 7 and 16 selected, therefore, the user does not need to move his/her finger further on segments 7 and 16 as shown in FIG. 13b.

Since the user's finger or stylus may partially block the view of the segmented pattern, in one embodiment, two segmented patterns, with some characters, are displayed (FIG. 14). As shown in FIG. 14, there may be a second segmented pattern (136) on a touch sensitive graphical user interface of an electronic device, wherein an indicator (132 and 134) of the input signal is displayed on activated segments of the second segmented pattern (136) according to the input signal received on at least one segment of the segmented pattern (138). There may be the steps of presenting a second segmented pattern on a touch sensitive graphical user interface of an electronic device; and displaying activated segments according to the input signal received on at least one segment. One segmented pattern is touched by the user and is used to draw the character and a second segmented pattern provides a clear view of the selected segments to the user. Selected segments correspond to input signals on at least one segment. A cursor on the second pattern displays the current position of the finger/stylus. In one embodiment, the second pattern is displayed close to the previous characters/symbols entered, thus, the user can easily see what he/she has written before.

In one embodiment, there is only one segmented pattern, with some characters displayed on it, and the segmented pattern is used to show the user what segments have been selected. The user does not touch the segmented pattern. He/she writes on the touch screen and from the location of the cursor on the segmented pattern decides how to move his/her finger or stylus.

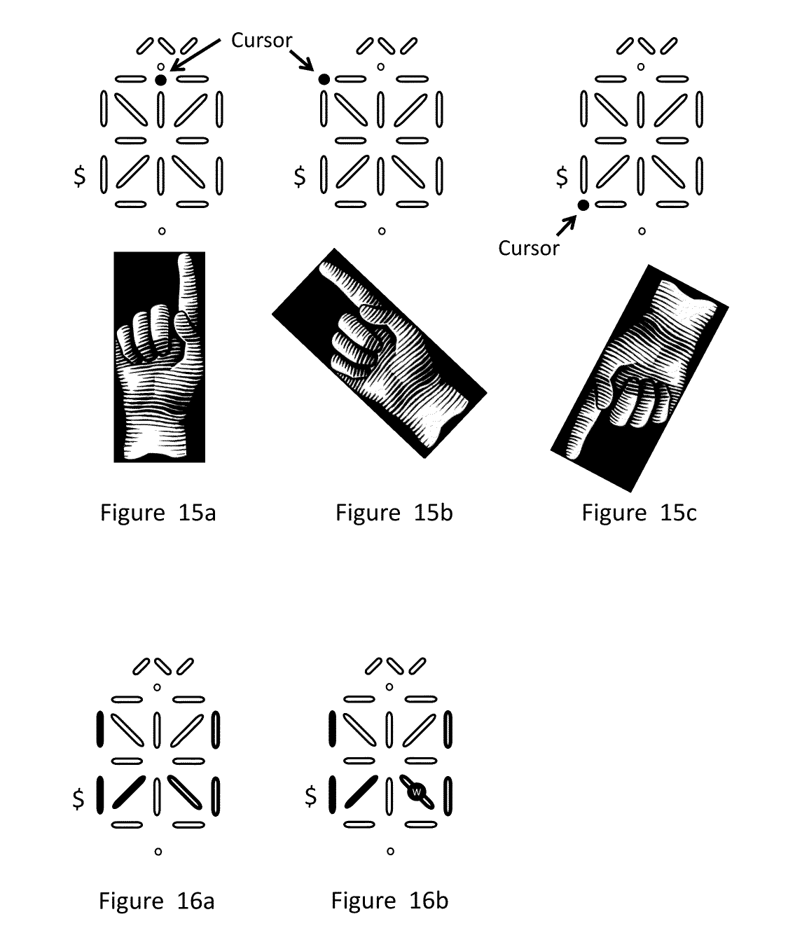

The input signal may be input by touch contact, stylus device contact and video input. In one embodiment, a camera is used to capture the video/image of the movement of the user's finger or the movement of a stylus or a pen and the movement is shown on a pattern. A cursor on the pattern will show the position of the finger. Moving the finger around will put the cursor on different parts of the pattern (FIGS. 15a, 15b and 15c). Pointing the finger at the camera and then moving the finger will be equivalent to moving finger on a touch screen and results in selecting segments.

In one embodiment, the segments of the pattern are added or deleted dynamically as the user touches other segments. For example, if the user enters character “E”, segments for accents might appear at the top of the segmented pattern in case the user wants to select them and write “Ê”. This can be especially good when inputting Chinese or Japanese Kanji characters which can be very complex and require patterns with many segments. In some languages, such as Japanese, there are rules for the order of writing strokes. A stroke is the sequence of all segments touched by the user starting when the user touches the screen and ending when he lifts his finger. It is possible to write “A” without lifting finger from the screen when writing. Alternatively, “A” may be written using two strokes: one for the horizontal line and the other for the rest of the character. In the context of this invention, a user can write characters without even lifting his finger after writing each character. The present invention, using an algorithm, can break the long sequence of segments into subsequences and convert each subsequence into a character unless some of the characters have been entered using the fast method (e.g., the characters are displayed on the segmented pattern and are entered by dragging a finger on a single segment), in which case the user must lift his finger from the touch screen before and after entering the character using the fast method. Alternatively, a user can lift his finger after writing each character or even can write a character with more than one stroke. This obviously eases the processing of the touched segments to recognize characters. This case is also handled in this invention. In one embodiment, based on the strokes drawn by the user, some segments are added to or omitted from the segmented pattern. The electronic device may backtrack and change the sequence of strokes based on the results of the matched characters or unmatched characters. A stroke may end when a user lifts their finger. In one embodiment, if the system/method/device has predicted which character the user is going to input (or enter), the predicted character is shown on the same pattern using a different color, style, etc. The predicted character is according to the input and the corresponding character table. For example, if the system knows that the letter “A” is associated with the set of numeric values 1, 2, 3, 4, 7, 8, 12, 16 and an input signal is received on line segments 1, 2, 3, 4, 7 and 8 (but not yet segments 12 and 16) it is able to predict that the character “A” is being input and displays the character “A” on a segmented pattern.

In FIG. 16a, the user has entered (or the processor has received input signals for) three segments and the system/method/device has predicted that the user wants to enter “W”, so the shape of three other segments corresponding to “W” has been changed. If the character is what the user has in mind, the user accepts it by, for example, pressing a button, pressing the middle of the segment predicted by the system/method/device to be touched next, or any other ways. In one embodiment, the predicted character is displayed close to the pattern. In one embodiment, the predicted character is displayed on the next segment the user is going to touch. In one embodiment, the user can accept the predicted character by touching the character displayed on the segment (FIG. 16b).

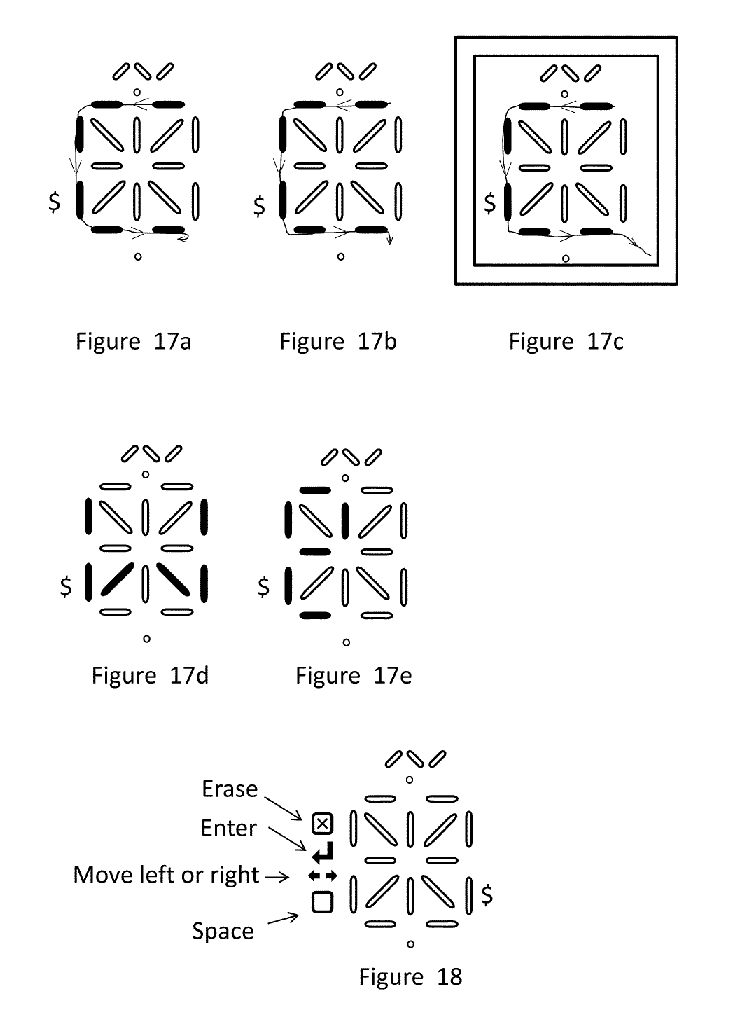

In order for the system/method/device to start processing touched segments, the user may signal that he has finished entering the character. Having an easy way for this is important because it impacts the speed of entering characters. The input may be further comprised of an end signal. FIGS. 17a, 17b and 17c depict examples of end signals. In one embodiment, the end is signaled by the user moving his finger/stylus in the reverse direction for a short period of time or a short distance (FIG. 17a). In one embodiment, the end is signaled by the user moving his finger/stylus in the direction perpendicular to his last move and for a short period of time or a short distance (FIG. 17b). In one embodiment, the user signals the end by touching an outside border or region (FIG. 17c). In one embodiment, the user signals the end of character by holding his/her finger on the screen for longer than a threshold value. In one embodiment, there are several segmented patterns for entering characters and the user signals the end of inputting a character on a segmented pattern by starting to write on another segmented pattern, except for the case in which it is the last character. In the case of the last character, the user signals the end of inputting a character on a segmented pattern according to one of the other described techniques. In one embodiment, the user signals the end by removing his finger/stylus from the screen for a period of time longer than a threshold. In one embodiment, the user signals the end by tapping on the touch screen. In one embodiment, the user signals the end by double tapping on the touch screen. In one embodiment, the user signals the end by touching the middle of the last segment which was touched. In one embodiment, for some characters, the end of writing is determined when there is no segment left which can be touched to create a valid character. In one embodiment, the user continuously writes on the pattern, while lifting his/her finger from the screen/touch pad to signal the end of each stroke. The system/method/device converts the inputs into strokes and combines the strokes to make characters. In FIGS. 17d and 17e, the user has entered two strokes. There is no character corresponding with the combination of the two strokes, but the first stroke corresponds to character “W” and the second stroke corresponds to character “e”. Thus, the two strokes must belong to different characters.

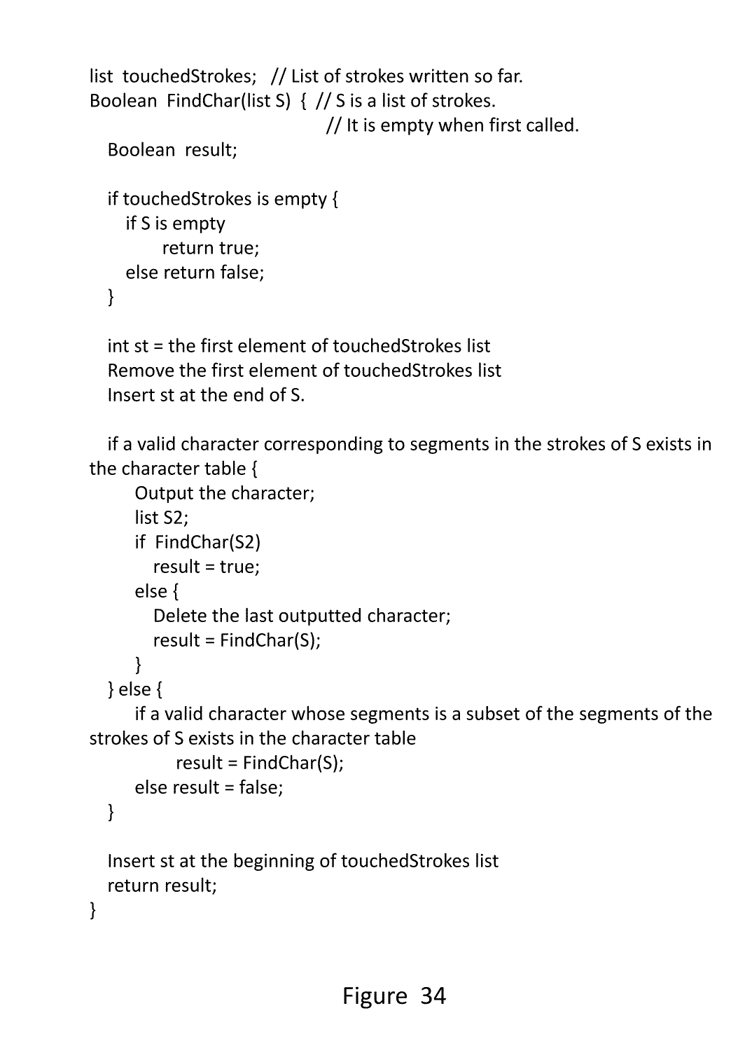

If there is ambiguity (i.e., there is more than one way of combining strokes to get valid characters/symbols), the system/method/device uses a dictionary to resolve the ambiguity (i.e., combines the strokes in such a way that the resulting characters build a valid word) or it uses the statistical information to pick the character/symbol with the highest occurrence frequency or it uses statistical information to pick the word with the highest occurrence frequency from the possible valid words which can be made from the written strokes and resolves the ambiguity. In this way, the step of predicting a character according to the input and the corresponding character table would include using a dictionary. In one embodiment, if a sequence of strokes cannot be processed into one or more characters, the system/method/device changes an earlier decision that was made to resolve an earlier ambiguity and reprocesses the strokes from that point. FIG. 34 shows the algorithm written in pseudocode. In the algorithm, after checking the character table to see if the set of segments correspond to a valid character, it is possible to check whether the valid character and previously detected characters correspond to a valid word in the dictionary; if both conditions hold, then the character can be written at the output. As an example of using a dictionary, consider the following strokes written by a user: {16,7,6}, {10, 14}, and {14,12,4,5}. Considering each stroke separately results in the following characters “c”, “l”, “o”. Combining the first and the second strokes results in the following characters, “d”, “o”. Combining the second and the third strokes results in the following characters, “c”, “b”. Combining all three strokes does not result in a valid character. From the all possibilities, only the second one, i.e., combining the first and the second strokes results in a valid word (i.e., “do”), which exists in the dictionary. Thus, the sequence of strokes corresponds to word “do”.

In one embodiment, different strokes may be displayed using different colors/styles of lines. Different strokes may be displayed using different colors/styles for selected segments. If a segment is selected in more than one stroke, different colors/styles may be combined. If a stroke has been processed and the character the stoke belongs to has been recognized by the system/method/device, the corresponding segments are erased. If a segment is selected in more than one stroke and later one or more of those strokes are processed and their corresponding characters are displayed, the colors/styles of the remaining strokes, which have not been processed yet, are combined.

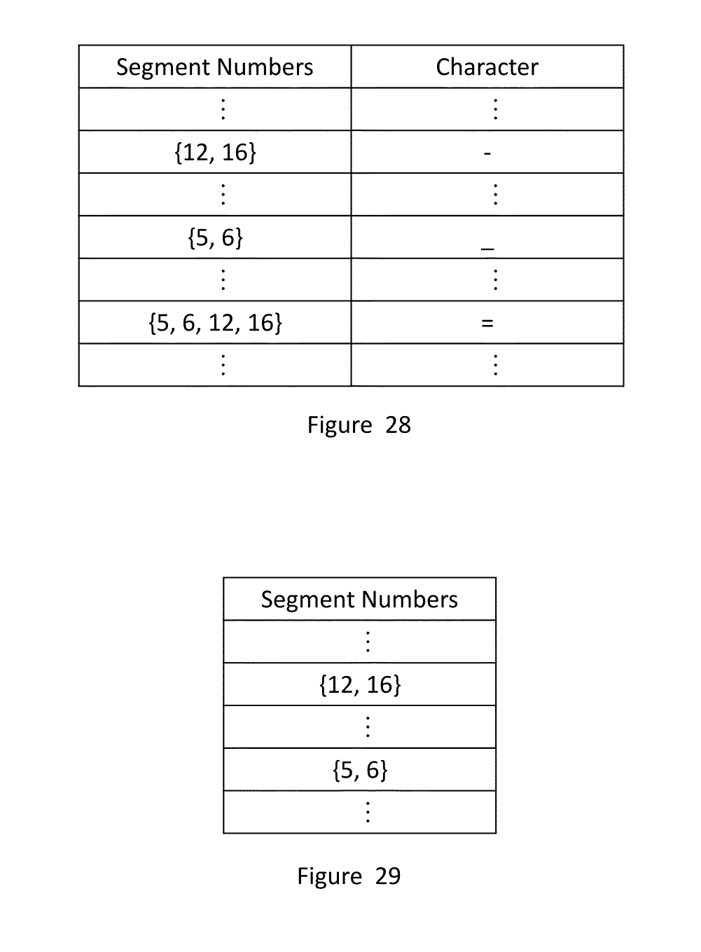

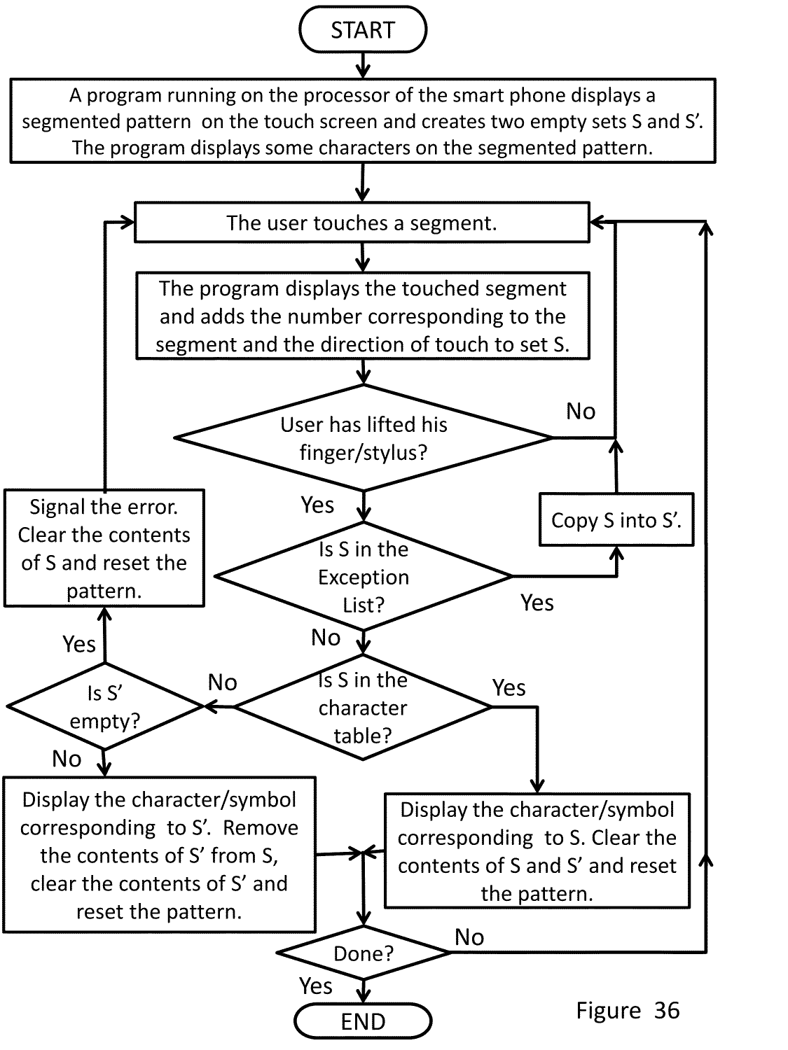

In one embodiment, lifting the user's finger signals the end of the character. In one embodiment, lifting the user's finger signals the end of the character unless the set of touched segments are in a list of sets (Exception List) which will be treated differently. In one embodiment, if the set of touched segments is in the Exception List, the system/method/device waits for the user to touch the next segment before processing the touched segments (FIG. 36). The Exception List can be used for the characters and symbols which cannot be written with a single stroke. FIG. 28 shows the definitions of “−”, “_” and “=”. Without having an Exception List, a user will not be able to write “=” because the system/method/device will process the touched segments when the user lifts his/her finger. FIG. 29 shows an example of the Exception List. Since both {5, 6} and {12, 16} are in the Exception List, when the user touches for example segments 5 and 6 and lifts his/her finger, the system/method/device waits for the next segment to be touched before deciding whether the entered character is “_” or “=”. In one embodiment, if the set of touched segments is in the Exception List, the system/method/device waits for a predefined time to see what other segment or segments the user touches if any, before processing the already touched segments. In one embodiment, if the set of touched segments is in the Exception List, the system/method/device waits for the user to press a special button (e.g., DONE button) before processing the touched segments. The exception list may be a part of the character table. In one embodiment, if there is no character corresponding to the touched segments, one or more segments of the pattern are reset. In one embodiment, if there is no character corresponding to the touched segments, the segmented pattern is not reset.

In one embodiment, the user does not need to signal the end of character if the character has more than two segments (characters are defined such that there won't be any ambiguity in constructing characters from strokes unless there is a character with one or two segments). If the character has only one or two segments, the user must wait longer than a threshold value before entering the character. In one embodiment, after entering a character which has one or two segments, the user must wait longer than a threshold value before entering the next character.

In one embodiment, the system/method/device does not take into account the order of touching segments when it tries to recognize the character. In one embodiment, the system/method/device takes into account the order of touching segments when it tries to recognize the character. Accordingly, the corresponding character table having numeric values may be order sensitive or not be order sensitive.

In one embodiment, the user can select a segment by touching it only if a particular segment or some particular segments have been touched before. In one embodiment, the user can select a segment by touching it only if a particular segment or some particular segments are touched before. In one embodiment, the user can select a segment by touching it only if a particular segment or some particular segments have been touched after it. In one embodiment, the user can select a segment by touching it only if a particular segment or some particular segments are touched after it. In one embodiment, touching an already selected segment, deselects the segment.

In one embodiment, the numbers (or characters) must be written at a particular region (e.g., right) of the pattern. In one embodiment, the numbers (or characters) must be written at left. In one embodiment, lower case characters must be written at a particular region of the pattern (e.g., lower portion of the pattern) when possible. In one embodiment, consecutive characters must be written at different regions of the pattern (e.g., first character at left and second character at right) whenever possible.

In one embodiment, only the uppercase letters can be written. This can simplify end of character detection and the character detection itself. In one embodiment, only the lowercase letters can be written. This can simplify end of character detection and the character detection itself.

In one embodiment, the segmented pattern is located on a touch screen or a touch pad at the back or the front of the device. In one embodiment, the segmented pattern is located on the back of a see-through touch screen.

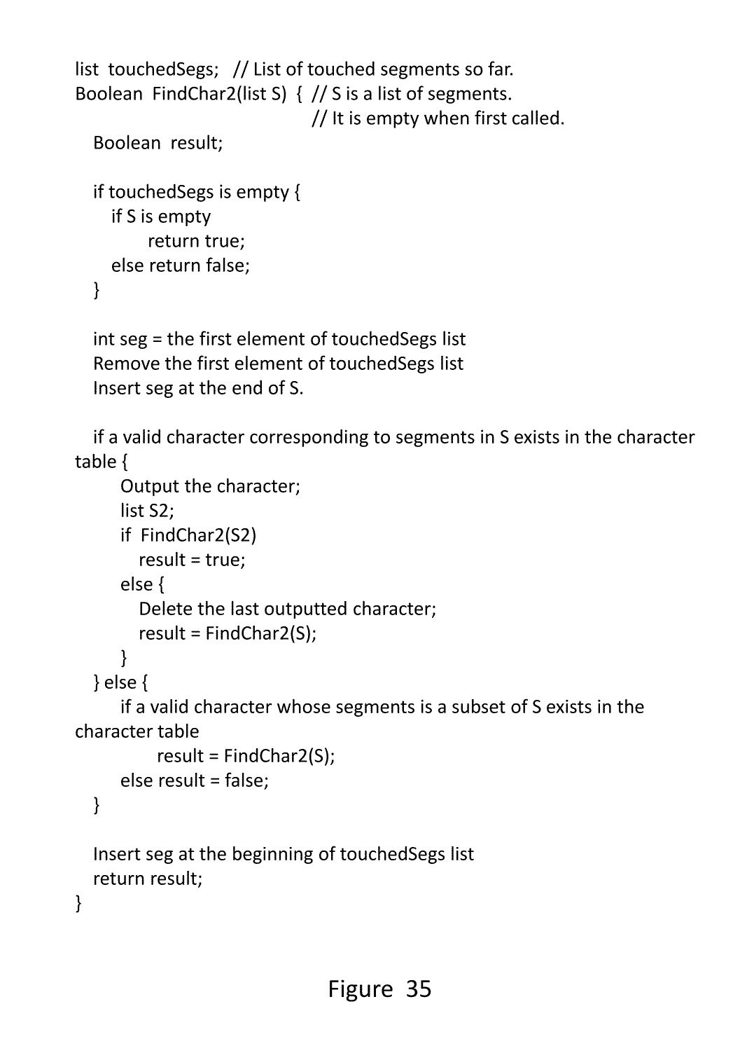

In one embodiment, unless the user is entering a character using the fast method (e.g., a character displayed on the segmented pattern is entered by dragging a finger on a single segment), she does not signal the end of the character; she continuously writes on the pattern and may not lift her finger from the touch screen or touch pad to signal the end of each stroke. The system/method/device converts the inputs (i.e., the sequence of touched segments) into characters based on the table of characters (i.e., the table which maps sets of segments and directions to characters) and a dictionary, which provides information about words (i.e., valid sequence of characters) (FIG. 35). As an example, consider the following sequence of segments written by a user: {7, 16, 14, 6, 7, 16}. There are several ways to break this sequence into subsequences in a way that each subsequence corresponds to a valid character, 1—{7, 16}, {14, 6, 7, 16} corresponding to characters “r” and “o”, 2—{7, 16, 14}, {6, 7, 16} corresponding to characters “n” and “c”, 3—{7, 16, 14, 6}, {7, 16} corresponding to characters “o” and “r”. Using a dictionary, it becomes clear that only the last way of breaking the sequence into subsequences results in a valid English word, thus, the sequence is broken into {7, 16, 14, 6} and {7, 16} and characters “o” and “r” are written at the output.

In one embodiment, special purpose buttons are added to the segmented pattern. In FIG. 18, five special purpose buttons are added to the pattern for erasing what has been written on the segmented pattern (i.e., resetting the segmented pattern), for enter key, for move left, for move right, and for inserting space. In one embodiment, special purpose buttons for different languages are added so the user can choose the language he/she wants to use. In one embodiment, more than one segmented pattern is used, each for a specific language. In this case, the user does not need to press a special purpose button to change the language; he/she just starts writing on a segmented pattern corresponding to a different language.

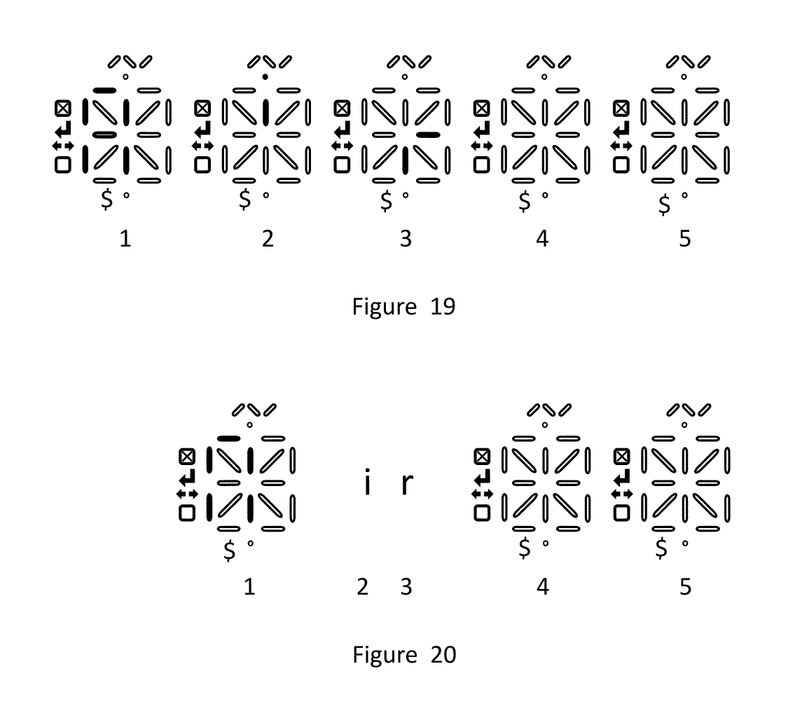

In one embodiment, the segmented pattern(s) is (are) displayed where the entered character must be displayed. Thus, the user will see the previous entered characters while entering a new character (FIG. 19).

In one embodiment, the system/method/device guesses what word the user wants to write and displays it on the screen. The user can accept the word by skipping the displayed word and continuing to enter the characters after the displayed word. The user can accept several of characters by writing a character immediately after the displayed characters. In FIG. 19, the user is writing “A” on pattern 1. The user has not entered the last segment yet. The system/method/device predicts that the user wants to write the word “Air” and displays “A”, “i” and “r” on patterns 1, 2 and 3, respectively. If the prediction is correct, the user can accept it by continuing the writing on pattern 5 to enter the next character. If the prediction is not correct, the user can erase the predicted characters (i.e., “i” and “r”), by erasing pattern 2 and writing on it (in one embodiment, just touching a segment of pattern 2 resets pattern 2 and pattern 3, thus, there will be no need to press the erase button before writing). If the second predicted character (i.e., “i”) is correct, but the third predicted character (i.e., “r”) is not correct, the user can erase the third character and continue by writing on pattern 3. It is noteworthy that previously entered characters, the character currently being entered and the predicted characters are all displayed close to each other, thus, there is no need for the user to constantly move his/her gaze from one point on the screen to another. This is in contrast to some virtual keyboard with word prediction used on smart phones, which require the user to move his/her gaze between three different locations on the screen. It is noteworthy that some buttons such as space and move left may be deleted in the above scenario.

In one embodiment, instead of displaying the predicted characters on segmented patterns, they are written on the screen. Touching one of the characters will replace the character with a pattern on which the user can write a new character (FIG. 20). In one embodiment, a piece of plastic/metal/etc. is put on the touch screen or touch pad to limit the movement of finger or stylus to make it easy for the user to enter characters possibly without looking at the pattern.

In one embodiment, after a character is recognized, it is pronounced. In one embodiment, after a character is recognized, a beep is played. This is an indicator of successfully detecting the input. Specifically it is an indicator that the input signal is providing a matched character determined by the electronic device according to the input and the corresponding character table.

In one embodiment, the table which maps segment numbers into characters (associating a set of numeric values to each character to provide a corresponding character table stored in the electronic device) can be edited by the user. In one embodiment, the corresponding character table can be automatically modified by the system/method/device based on the user's behavior (e.g., there are two entries for character “A” in the table, one entry corresponds to writing the character at left and a second entry corresponds to writing the character at right. If the user writes character “A” always on the left side of the pattern, the system/method/device can delete the second entry. This can reduce the error rate if the system/method/device tries to guess the intended character in presence of user error).

In one embodiment, the size of the segmented pattern and/or the distance of segments can be changed by the user. In one embodiment, the size of the segmented pattern and/or the distance of segments can be changed by the system/method/device based on the user's behavior, the errors occurred while entering characters and the error rate.

In one embodiment, the size of the sensitive part of the segments can be changed by the user. In one embodiment, the size of the sensitive part of the segments can be changed by the system/method/device based on the user's behavior, the errors occurred while entering characters and the error rate.

In one embodiment, the orientation/angle of the segmented pattern can be changed by the user. In one embodiment, the orientation/angle of the segmented pattern can be changed by the system/method/device based on the user's behavior, the errors occurred while entering characters and the error rate.

In one embodiment, some segments are selected only if they are touched in particular directions. In one embodiment, some segments are selected only by tapping on them. In one embodiment, some segments cannot be selected by tapping on them. In some embodiments, the at least one segment is accepted as an input signal received on at least one segment of the segmented pattern only when input is in a particular direction. For example, the segment may be pressed, tapped or touched in a direction left to right on the segment for it to be accepted as an input signal. If the segment is pressed, tapped or touched in any other direction (for example, right to left) it would not be accepted as an input signal and would be ignored. This can reduce the error rate. For example if the pattern of FIG. 7b is small, when touching one of the top horizontal segments the top circle may be touched and selected accidentally. The error is prevented if the top circle can be selected by tapping only.

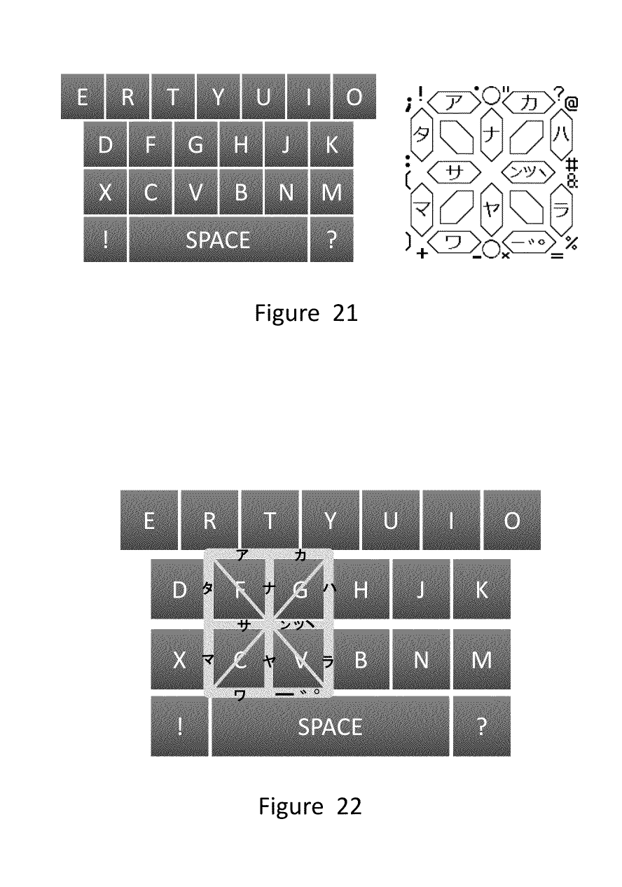

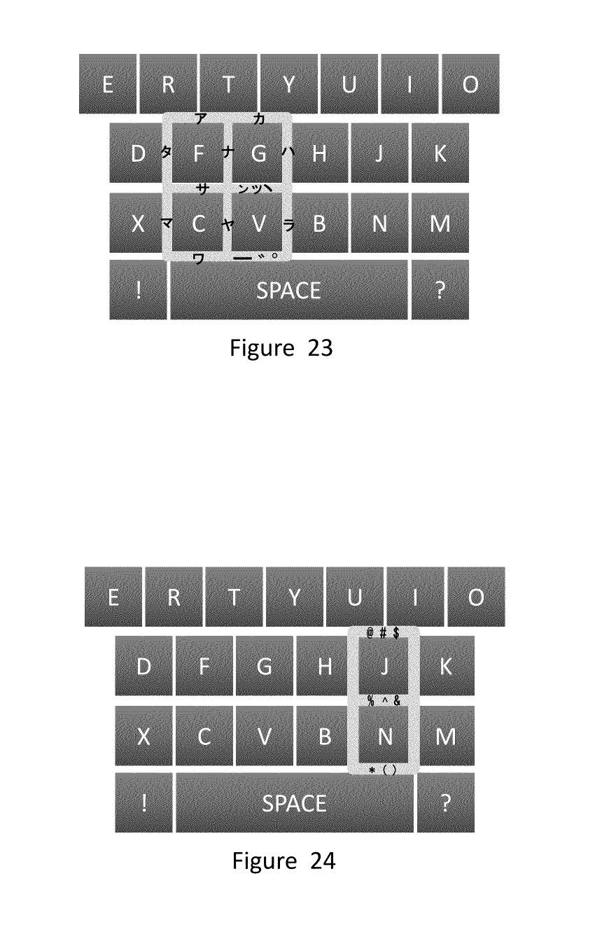

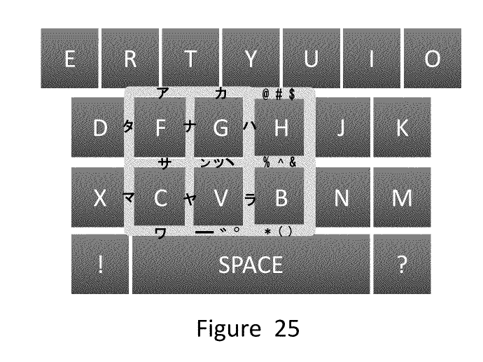

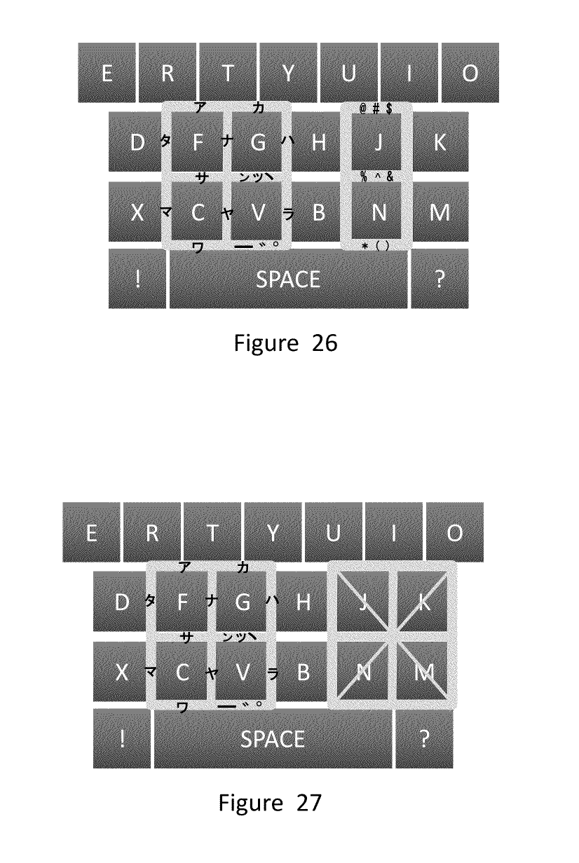

In one embodiment, the segmented pattern, with some characters displayed, is used in conjunction with a physical or virtual keyboard. The segmented pattern may be used to enter characters not supported by the keyboard or to enter characters in a different language, while the keyboard can be used to quickly enter limited characters supported by the keyboard (FIG. 21). In one embodiment, the segmented pattern is displayed on a virtual keyboard. This reduces the total footprint of the keyboard and the segmented pattern. In one embodiment, the segmented pattern is displayed between keys of a virtual keyboard (FIG. 22, 23, 24, 25). In one embodiment, at least two segmented pattern is displayed between keys of a virtual keyboard (FIG. 26, 27).

In one embodiment, there are buttons which can be used to change the language supported by the segmented pattern. In one embodiment, there are buttons which can be used to change the segmented pattern itself (e.g., displaying a pattern with a different number of segments).

In one embodiment, pinyin is used to enter Chinese characters. In one embodiment, hiragana is used to enter Japanese Kanji characters. In one embodiment, there is more than one segmented pattern and depending on which segmented pattern the characters are written the conversion to Kanji may or may not be performed. Thus, it will not be necessary to press an additional key to switch between modes or to tell the system/method/device to do the conversion.

In one embodiment, the strokes and selected segments are recorded so the user can look at them later to verify the accuracy of data entry and conversion. In some languages, characters are usually written in a particular direction (e.g., from left to right). In one embodiment, the system/method/device uses the direction of writing a character to detect the language. In one embodiment, the system/method/device uses the direction of writing a character to detect the character (i.e., if the set of touched segments correspond to valid characters in more than one language, the direction of writing the character is used to detect the language and resolve the ambiguity about the intended character). The direction of the input signal received on at least one segment of the segmented pattern may be determined according to the input having numeric values associated with each of the segments. For example, with reference to FIG. 2, if the user touches the segments (8, 9 and 10) in that order on the touch screen, we know the user's finger is moving left to right. In contrast, if the user touches the segments (10, 9 and 8) in that order, we know the user's finger is moving right to left. In one embodiment, the system/method/device uses the previous written character or characters to detect the language and resolve the ambiguity if the set of touched segments correspond to multiple characters in multiple languages.

In one embodiment, the character table is searched to find if the set of touched segments is valid (i.e., corresponds to a character).

In one embodiment, if there is no character corresponding with the touched segments, the system/method/device searches the table, which has the mapping of set of touched segments to characters, and finds the character whose set of touched segments, C, is close to the set of touched segments by the user (set U). In one embodiment, the character is chosen such that the intersection of U with C has the maximum number of segments. In one embodiment, the character is chosen such that (C-U) union with (U-C) has the minimum number of segments. In one embodiment, the character is chosen, such that it minimizes a function F(C, U). In one embodiment, F(C, U) is a weighted sum of the segments of U, C, the intersection of U and C, U-C, and C-U.

In one embodiment, the system/method/device is integrated with a controller to allow inputting characters/symbols easily. In one embodiment, the controller is a remote controller. In one embodiment, the controller is a remote controller of a TV. In one embodiment, the controller is a remote controller of a TV set top box. In one embodiment, the controller is a remote controller of an internet TV or a smart TV.

In one embodiment, the system/method/device is integrated with a device to allow entering characters/symbols into a tablet, cell phone, or laptop. In one embodiment, the device communicates with the tablet, cell phone, or laptop wirelessly. In one embodiment, the device is used to access social networking sites.

In one embodiment, the system/method/device is integrated within a watch. In one embodiment, the system/method/device is integrated within a portable music player.

In one embodiment, the system/method/device is integrated with the touch pad of a laptop. In one embodiment, the system/method/device is integrated with an external touch pad of a computer (e.g., a peripheral).

In one embodiment, the system/method/device is used for entering numbers only. In one embodiment, the system/method/device has a 7-segment pattern and is used for entering numbers only. In one embodiment, the system/method/device is used for entering numbers and punctuations only. In one embodiment, the system/method/device is used for entering numbers and arithmetic operations.

In one embodiment, the system/method/device is integrated with a physical or a virtual keyboard. In one embodiment, the system/method/device is integrated with a virtual keyboard and the pattern is displayed on the virtual keyboard. In one embodiment, the system/method/device is integrated with a virtual keyboard and a 7-segment pattern is displayed between the keys of the virtual keyboard. The pattern is used for entering numbers and punctuations.

There may be a system for inputting data in an electronic device utilizing both a keyboard and a segmented pattern with some characters displayed on it, the system having a segmented pattern on a touch sensitive graphical user interface of an electronic device, the segmented pattern having at least two segments; a numeric value in the electronic device associated to each of the at least two segments; a character table stored in the electronic device, the said character table having at least one set of numeric values associated to at least one character; a set of characters displayed on the segmented pattern, each said character associated to at least one segment of the segmented pattern and the numeric value of that said segment is in at least one set of the numeric values stored in the character table and the said set is associated to the said character; an input signal received on at least one segment of the segmented pattern to provide an input having numeric values associated with each of the segments; a matched character determined by the electronic device according to the input having numeric values and the character table; a keyboard in communication with the touch sensitive graphical user interface of the electronic device, wherein the keyboard accepts keyboard character input; wherein the matched character and the keyboard character input is displayed on the touch sensitive graphical user interface of an electronic device and stored in the electronic device and the segmented pattern on the touch sensitive graphical user interface of the electronic device is reset. The input signal may be ended in response to any keyboard character input. The keyboard may be a virtual keyboard (See, for example, FIG. 21) and may have the segmented pattern displayed on the virtual keyboard (See, for example, FIG. 22). The keys are sensitive to pressing by a finger or stylus.

There may be a system for inputting data in an electronic device utilizing both a keyboard and a segmented pattern with some characters displayed on it, the system having a segmented pattern on a touch sensitive graphical user interface of an electronic device, the segmented pattern having at least two segments; a numeric value in the electronic device associated to each of the at least two segments; a character table stored in the electronic device, the said character table having at least one set of numeric values associated to at least one character; a set of characters displayed on the segmented pattern, each said character associated to at least one segment of the segmented pattern and the numeric value of that said segment is in at least one set of the numeric values stored in the character table and the said set is associated to the said character; an input signal received on at least one segment of the segmented pattern to provide an input having numeric values associated with each of the segments; a matched character determined by the electronic device according to the input having numeric values and the character table; a keyboard in communication with the touch sensitive graphical user interface of the electronic device, wherein the keyboard accepts keyboard character input; wherein the matched character and the keyboard character input is displayed on the touch sensitive graphical user interface of an electronic device and stored in the electronic device and the segmented pattern on the touch sensitive graphical user interface of the electronic device is reset. The input signal may be ended in response to any keyboard character input. The keyboard may be a virtual keyboard (See, for example, FIG. 21) and may have the segmented pattern displayed on the virtual keyboard (See, for example, FIG. 22). The keys are sensitive to pressing by a finger or stylus. In one embodiment, the user input and some entries of the character table have information about the direction of touching the segments (FIG. 3c).

Also provided is a system for inputting data in an electronic device, the system comprising: a segmented pattern on a touch sensitive graphical user interface of an electronic device, the segmented pattern having at least two segments and restricting input signals according to a set of predetermined rules; a set of characters displayed on the segmented pattern; an input signal received on at least a portion of a segment to provide an input having the coordinates of touched points; a matched character determined by the electronic device according to input having the coordinates of touched points and at least one algorithm; wherein the matched character is displayed on the touch sensitive graphical user interface of an electronic device and stored in the electronic device and the segmented pattern on the touch sensitive graphical user interface of the electronic device is reset.

In this embodiment, a segmented pattern is used to restrict the way a user will write characters according to a set of predetermined rules (e.g., the user will be limited to write characters and symbols as illustrated in FIG. 30 or to tap or drag his finger on segments to enter characters displayed on the segmented patterns, i.e., use the fast method of data entry). The system/device/method will use one of the many character recognition algorithms to detect the written character. This will reduce the error rate of the character recognition algorithm.

In one embodiment, at least one algorithm is a neural network based algorithm used to detect the written characters. A neural network is first trained using an initial set of hand written characters on the segmented pattern. For example, one or more persons will write character “A” 100 times, in each case trying to write it as illustrated in FIG. 1c. The neural network is trained using these 100 samples and other samples which do not correspond to character “A”. After that the neural network is used to detect character “A”. In addition to the shape of the characters, the segmented pattern restricts their sizes and rotations, both of which simplify the preprocessing steps typically used in neural based algorithms.

In one embodiment, a feature extraction based algorithm is used to detect a written character. In these algorithms, important features of the image of the character such as the aspect ratio, the average distance of pixels from the center of the image, the x-axis symmetry, the y-axis symmetry, the percentage of pixels on each side of the horizontal or vertical half point are calculated and used to detect the written character. In addition to the shape of the characters, the segmented pattern restricts their sizes and rotations, both of which simplify the preprocessing steps which maybe use in feature extraction based algorithms.

In a neural network, each neuron calculates the following function,

Sum=X1*W1+X2*W2+Xn*Wn

where X1, . . . , Xn are the inputs and W1, . . . , Wn are the weights. If Sum is greater than or equal to a threshold value, th, the output will be 1. Otherwise, it will be 0.

For each character, there is a neuron, whose weights are calculated such that the output of the neuron is 1 if the input values correspond to the character. Otherwise, the output is 0.

Inputs X1, . . . , Xn correspond to the pixels of the touch screen where the segmented pattern is displayed. Xi is 1 if its corresponding pixel has been touched when writing the character on the screen. Otherwise, it is 0.

For each character, a training set, containing training vectors, is constructed. Each training vector <X1, X2, . . . , Xn, y_e> is constructed by writing the specific character and other characters on the segmented pattern multiple times (y_e is the correct or expected output value of the neuron. y_e is 1 if the vector corresponds to the specific character; otherwise, it is 0).

Next, the training set of each character is used to train its corresponding neuron to detect the character.

Training Algorithm:

Set all weights and threshold values to small random numbers.

done = false;
while (!done) {

done = true;
for each training vector of the training set {

Calculate Sum = X1*W1 + X2*W2 + ... + Xn*Wn
If Sum >= th

y = 1;

```
else y = 0;
If y ! = y_e {
  done = false;
  for 0 <= i <= n {
```

Update the value of Wi according to an algorithm; // E.g.,
Wi = Wi + alpha *

(y_e − y) * Xi, where 0 < alpha <1.

}
}

}

}

After calculating the weights of all neurons, the neurons can be used to recognize the character. In other words, the values of X1, . . . , Xn corresponding to a character written by the user can be used to calculate the output of the neurons and detect the character.

The above describes a basic algorithm. It is possible to change it in many ways. For example, the way the weights are updated can be changed. It is also possible to use a multilayer network, in which the outputs of neurons of one layer are the inputs of the neurons of the next layer (except the outputs of the neurons of the last layer, which are the outputs of the neural network). It is also possible to have feedback from the neurons of one layer to the neurons of one of its preceding layers (i.e., the outputs of the neurons of one layer may be used as some inputs to the neurons of a preceding layer).

According to another aspect of the present invention, a method for inputting data in an electronic device is provided, the method comprising: presenting a segmented pattern on a touch sensitive graphical user interface of an electronic device, the segmented pattern having at least two segments; associating a numeric value in the electronic device to each of the at least two segments; a character table stored in the electronic device, the said character table having at least one set of numeric values associated to at least one character; a set of characters displayed on the segmented pattern, each said character associated to at least one segment of the segmented pattern and the numeric value of that said segment is in at least one set of the numeric values stored in the character table and the said set is associated to the said character; receiving an input signal on at least one segment of the segmented pattern to provide an input having numeric values associated with each of the segments; determining a sequence of at least one segment according to the input having numeric values and the character table; determining a matched character according to the input having numeric values, the sequence and the corresponding character table; displaying the matched character on the touch sensitive graphical user interface of an electronic device; storing the matched character in the electronic device; and resetting the segmented pattern on the touch sensitive graphical user interface of the electronic device. The method may further comprise the steps of: of determining the direction of the input signal received on at least one segment of the segmented pattern according to the input having numeric values associated with each of the segments; searching a character table which has the direction information for some entries to find a matched character. The method may further comprise the steps of: of determining the direction of the input signal received on at least one segment of the segmented pattern according to the input having numeric values associated with each of the segments; searching a character table which has the direction information for some entries to find a matched character; ignoring the direction of the input signal and searching the character table a second time if the first search did not find a match. The method may further comprise the steps of: backtracking and changing the sequence chosen from input signals received on at least one segment based on the results of matched characters or unmatched characters determined by the electronic device according to the input having numeric values and the character table. According to another aspect of the present invention, the method may further comprise the steps of analyzing the result of the matched characters using a dictionary; and backtracking to change the sequence chosen from input signals. According to another aspect of the present invention, the method may further comprise the steps of determining the direction of the input signal received on at least one segment of the segmented pattern according to the input having numeric values associated with each of the segments; and detecting the language and character the user is writing according to the input having numeric values and the character table. According to another aspect of the present invention, the method may further comprise the steps of detecting the language the user is writing in according to at least two dictionaries of at least two languages. According to another aspect of the present invention, the method may further comprise the steps of determining whether there is an absence of a matched character; providing a matched character, in the absence of a matched character, according to the input having numeric values, the sequence and the closest character in the character table. According to another aspect of the present invention, the sequence of the input signals received on at least two segments is the shortest possible sequence. According to another aspect of the present invention, the displayed characters are English characters. According to another aspect of the present invention, the displayed characters are Korean characters. According to another aspect of the present invention, the displayed characters are used to enter Japanese characters. According to another aspect of the present invention, the displayed characters are punctuations. According to another aspect of the present invention, the displayed characters are 0-9 digits. According to another aspect of the present invention, the method is used to enter characters in more than one language. According to another aspect of the present invention, the method is used to enter characters in two languages. According to another aspect of the present invention, there is at least one segment to which three characters are associated to. According to another aspect of the present invention, there is at least one segment to which three characters are associated to and the characters are entered by tapping on the segment and dragging the finger from one side of the segment to the other side. According to another aspect of the present invention, there is at least one segment to which at least one character has been assigned and the character is entered by dragging finger on the segment twice. According to another aspect of the present invention, there is at least one segment to which five characters are assigned and the characters are entered by tapping or dragging finger on the segment from right to left, left to right, down to up and up to down. According to another aspect of the present invention, the sequence of the input signals received on at least two segments is the shortest possible sequence. According to another aspect of the present invention, the sequence of the input signals received on at least two segments ends at the point an input signal is not being received on the segmented pattern of the touch sensitive graphical user interface a point the user had lifted his finger/stylus. According to another aspect of the present invention, the sequence ends at the point an input signal is not being received on the segmented pattern of the touch sensitive graphical user interface unless the sequence of the inputs received on at least one segment is in an exception list. According to another aspect of the present invention, at least one segment is accepted as an input signal received on at least one segment of the segmented pattern in a particular direction. According to another aspect of the present invention, the input signal is selected from the group consisting of touch contact, stylus device contact and video input. According to another aspect of the present invention, an input signal received on at least one segment of the segmented pattern is converted to strokes, a sequence of strokes are selected, and the sequence of segments are built from the sequence of strokes. According to another aspect of the present invention, the method may further comprise the steps of backtracking, by the electronic device, and changing the sequence of strokes selected based on the results of the matched characters or unmatched characters. According to another aspect of the present invention, the method may further comprise the steps of accepting keyboard character input in a keyboard in communication with a touch sensitive graphical user interface of the electronic device. According to another aspect of the present invention, the method may further comprise the steps of accepting keyboard character input in a virtual keyboard in communication with a touch sensitive graphical user interface of the electronic device; providing a segmented pattern on the virtual keyboard, the segmented pattern having at least two segments; associating a numeric value in the electronic device to each of the at least two segments; a character table stored in the electronic device, the said character table having at least one set of numeric values associated to at least one character; a set of characters displayed on the segmented pattern, each said character associated to at least one segment of the segmented pattern and the numeric value of that said segment in at least one set of the numeric values stored in the character table and the said set is associated to the said character; receiving an input signal on at least one segment of the segmented pattern to provide an input having numeric values associated with each of the segments; and determining a matched character by the electronic device according to the input having numeric values and the character table; displaying the matched character and the keyboard character input on the touch sensitive graphical user interface of an electronic device; storing the matched character and the keyboard character input in the electronic device; and resetting the segmented pattern on the touch sensitive graphical user interface of the electronic device. According to another aspect of the present invention, the method may further comprise the steps of: of determining the direction of the input signal received on at least one segment of the segmented pattern according to the input having numeric values associated with each of the segments; searching a character table which has the direction information for some entries to find a matched character. The method may further comprise the steps of: of determining the direction of the input signal received on at least one segment of the segmented pattern according to the input having numeric values associated with each of the segments; searching a character table which has the direction information for some entries to find a matched character; ignoring the direction of the input signal and searching the character table a second time if the first search did not find a match. According to another aspect of the present invention, the displayed characters are English characters. According to another aspect of the present invention, the displayed characters are Korean characters. According to another aspect of the present invention, the displayed characters are used to enter Japanese characters. According to another aspect of the present invention, the displayed characters are punctuations. According to another aspect of the present invention, the displayed characters are 0-9 digits. According to another aspect of the present invention, the method is used to enter characters in more than one language. According to another aspect of the present invention, the method is used to enter characters in two languages. According to another aspect of the present invention, there is at least one segment to which three characters are associated to. According to another aspect of the present invention, there is at least one segment to which three characters are associated to and the characters are entered by tapping on the segment and dragging the finger from one side of the segment to the other side. According to another aspect of the present invention, there is at least one segment to which at least one character has been assigned and the character is entered by dragging finger on the segment twice. According to another aspect of the present invention, there is at least one segment to which five characters are assigned and the characters are entered by tapping or dragging finger on the segment from right to left, left to right, down to up and up to down. According to another aspect of the present invention, the method may further comprise the step of accepting any keyboard character input on the keyboard denotes the end of the input signal. According to another aspect of the present invention, the method may further comprise the steps of: selecting segments of the segmented pattern by dragging a finger/stylus on the touch screen and the keys are sensitive to pressing the finger/stylus. According to another aspect of the present invention, the method may further comprise the steps of: providing a segmented pattern on a touch sensitive graphical user interface of an electronic device, the segmented pattern having at least two segments; providing a numeric value in the electronic device associated to each of the at least two segments; a character table stored in the electronic device, the said character table having at least one set of numeric values associated to at least one character; a set of characters displayed on the segmented pattern, each said character associated to at least one segment of the segmented pattern and the numeric value of that said segment is in at least one set of the numeric values stored in the character table and the said set is associated to the said character; receiving an input signal received on at least one segment of the segmented pattern to provide an input having numeric values associated with each of the segments; determining a matched language and a matched character by the electronic device according to the keyboard, character input converted into numeric values, input having numeric values and the character table; wherein the matched character in the matched language is displayed on the touch sensitive graphical user interface of an electronic device and stored in the electronic device and the segmented pattern on the touch sensitive graphical user interface of the electronic device is reset. According to another aspect of the present invention, the method may comprise the steps of: providing at least two segmented patterns on a touch sensitive graphical user interface of an electronic device, each segmented pattern having at least two segments; providing a numeric value in the electronic device associated to each of the at least two segments; a character table stored in the electronic device, the said character table having at least one set of numeric values associated to at least one character; a set of characters displayed on the segmented pattern, each said character associated to at least one segment of the segmented pattern and the numeric value of that said segment is in at least one set of the numeric values stored in the character table and the said set is associated to the said character; receiving an input signal on at least one segment of the segmented pattern to provide an input having numeric values associated with each of the segments; determining a matched character by the electronic device according to the input and the corresponding character table; wherein an indicator of the input signal is displayed on segments of a second segmented pattern according to the input signal received on at least one segment of a first segmented pattern and the matched character is displayed on the touch sensitive graphical user interface of the electronic device and stored in the electronic device and the first and second segmented patterns are reset. According to another aspect of the present invention, the method may further comprise the steps of: of determining the direction of the input signal received on at least one segment of the segmented pattern according to the input having numeric values associated with each of the segments; searching a character table which has the direction information for some entries to find a matched character. The method may further comprise the steps of: of determining the direction of the input signal received on at least one segment of the segmented pattern according to the input having numeric values associated with each of the segments; searching a character table which has the direction information for some entries to find a matched character; ignoring the direction of the input signal and searching the character table a second time if the first search did not find a match. According to another aspect of the present invention, the displayed characters are English characters. According to another aspect of the present invention, the displayed characters are Korean characters. According to another aspect of the present invention, the displayed characters are used to enter Japanese characters. According to another aspect of the present invention, the displayed characters are punctuations. According to another aspect of the present invention, the displayed characters are 0-9 digits. According to another aspect of the present invention, the method is used to enter characters in more than one language. According to another aspect of the present invention, the method is used to enter characters in two languages. According to another aspect of the present invention, there is at least one segment to which three characters are associated to. According to another aspect of the present invention, there is at least one segment to which three characters are associated to and the characters are entered by tapping on the segment and dragging the finger from one side of the segment to the other side. According to another aspect of the present invention, there is at least one segment to which at least one character has been assigned and the character is entered by dragging finger on the segment twice. According to another aspect of the present invention, there is at least one segment to which five characters are assigned and the characters are entered by tapping or dragging finger on the segment from right to left, left to right, down to up and up to down. According to another aspect of the present invention, the method may comprise the steps of displaying at least two segmented patterns on a touch sensitive graphical user interface of an electronic device, each segmented pattern having at least two segments; associating a numeric value in the electronic device associated to each of the at least two segments; a character table stored in the electronic device, the said character table having at least one set of numeric values associated to at least one character; a set of characters displayed on the segmented pattern, each said character associated to at least one segment of the segmented pattern and the numeric value of that said segment in at least one set of the numeric values stored in the character table and the said set is associated to the said character; receiving an input signal received on at least one segment of the segmented pattern to provide an input having numeric values associated with each of the segments; determining a matched character by the electronic device according to the input having numeric values and the corresponding character table; wherein the matched character is displayed in place of the segmented pattern displayed on a touch sensitive graphical user interface of an electronic device on which the input signal was received, stored in the electronic device and the segmented pattern on the touch sensitive graphical user interface of the electronic device is reset. According to another aspect of the present invention, the method may further comprise the steps of: of determining the direction of the input signal received on at least one segment of the segmented pattern according to the input having numeric values associated with each of the segments; searching a character table which has the direction information for some entries to find a matched character. The method may further comprise the steps of: of determining the direction of the input signal received on at least one segment of the segmented pattern according to the input having numeric values associated with each of the segments; searching a character table which has the direction information for some entries to find a matched character; ignoring the direction of the input signal and searching the character table a second time if the first search did not find a match. According to another aspect of the present invention, the displayed characters are English characters. According to another aspect of the present invention, the displayed characters are Korean characters. According to another aspect of the present invention, the displayed characters are used to enter Japanese characters. According to another aspect of the present invention, the displayed characters are punctuations. According to another aspect of the present invention, the displayed characters are 0-9 digits. According to another aspect of the present invention, the method is used to enter characters in more than one language. According to another aspect of the present invention, the method is used to enter characters in two languages. According to another aspect of the present invention, there is at least one segment to which three characters are associated to. According to another aspect of the present invention, there is at least one segment to which three characters are associated to and the characters are entered by tapping on the segment and dragging the finger from one side of the segment to the other side. According to another aspect of the present invention, there is at least one segment to which at least one character has been assigned and the character is entered by dragging finger on the segment twice. According to another aspect of the present invention, there is at least one segment to which five characters are assigned and the characters are entered by tapping or dragging finger on the segment from right to left, left to right, down to up and up to down. According to another aspect of the present invention, the method may further comprise the steps of providing a dictionary, wherein a predicted character the user is going to write is predicted according to the dictionary, previously written words by the user, the input having numeric values, and the corresponding character table and the predicted character is displayed on the segmented pattern. A user can select at least one predicted character, by continuing to input an input signal on a segmented pattern displayed on a touch sensitive graphical user interface of an electronic device after the predicted character is displayed. According to another aspect of the present invention, the method may comprise the steps of providing a segmented pattern on a touch sensitive graphical user interface of an electronic device, the segmented pattern having at least two segments and restricting input signals according to a set of predetermined rules; displaying a set of characters on the segmented pattern; receiving an input signal received on at least a portion of a segment to provide an input having the coordinates of touched points; determining a matched character by the electronic device according to input having the coordinates of touched points and an algorithm; wherein the matched character is displayed on the touch sensitive graphical user interface of an electronic device and stored in the electronic device and the segmented pattern on the touch sensitive graphical user interface of the electronic device is reset. The algorithm is a neural network based algorithm. According to another aspect of the present invention, a method for inputting data in an electronic device is provided, the method comprising: a virtual keyboard in communication with a touch sensitive graphical user interface of the electronic device, wherein said virtual keyboard accepts keyboard character input; a segmented pattern on the virtual keyboard, the segmented pattern having at least two segments; a numeric value in the electronic device associated to each of the at least two segments; a character table stored in the electronic device, the said character table having at least one set of numeric values associated to at least one character; a set of characters displayed on the segmented pattern, each said character associated to at least one segment of the segmented pattern and the numeric value of that said segment in at least one set of the numeric values stored in the character table and the said set associated to the said character; an input signal received on at least one segment of the segmented pattern to provide an input having numeric values associated with each of the segments; an input signal received on at least one segment of the segmented pattern to provide an input having numeric values associated with each of the segments; a matched character determined by the electronic device according to the input having numeric values and the character table; wherein the matched character and the keyboard character input is displayed on the touch sensitive graphical user interface of an electronic device and stored in the electronic device and the segmented pattern on the touch sensitive graphical user interface of the electronic device is reset. According to another aspect of the present invention, the method may further comprise the steps of: of determining the direction of the input signal received on at least one segment of the segmented pattern according to the input having numeric values associated with each of the segments; searching a character table which has the direction information for some entries to find a matched character. According to another aspect of the present invention, the method may further comprise the steps of: of determining the direction of the input signal received on at least one segment of the segmented pattern according to the input having numeric values associated with each of the segments; searching a character table which has the direction information for some entries to find a matched character; ignoring the direction of the input signal and searching the character table a second time if the first search did not find a match. According to another aspect of the present invention, the displayed characters are English characters. According to another aspect of the present invention, the displayed characters are Korean characters. According to another aspect of the present invention, the displayed characters are used to enter Japanese characters. According to another aspect of the present invention, the displayed characters are punctuations. According to another aspect of the present invention, the displayed characters are 0-9 digits. According to another aspect of the present invention, the method is used to enter characters in more than one language. According to another aspect of the present invention, the method is used to enter characters in two languages. According to another aspect of the present invention, there is at least one segment to which three characters are associated to. According to another aspect of the present invention, there is at least one segment to which three characters are associated to and the characters are entered by tapping on the segment and dragging the finger from one side of the segment to the other side. According to another aspect of the present invention, there is at least one segment to which at least one character has been assigned and the character is entered by dragging finger on the segment twice. According to another aspect of the present invention, there is at least one segment to which five characters are assigned and the characters are entered by tapping or dragging finger on the segment from right to left, left to right, down to up and up to down. According to another aspect of the present invention, a method for inputting data in an electronic device is provided, the method comprising: presenting a segmented pattern on a touch sensitive graphical user interface of an electronic device, the segmented pattern having at least two segments; associating a numeric value in the electronic device to each of the at least two segments; a character table stored in the electronic device, the said character table having at least one set of numeric values associated to at least one character; a set of characters displayed on the segmented pattern, each said character associated to at least one segment of the segmented pattern and the numeric value of that said segment is in at least one set of the numeric values stored in the character table and the said set is associated to the said character; receiving an input signal on at least one segment of the segmented pattern to provide an input having numeric values associated with each of the segments; determining that entry of input signal is complete; determining a matched character according to the input having numeric values and the corresponding character table; displaying the matched character on the touch sensitive graphical user interface of an electronic device; storing the matched character in the electronic device; and resetting the segmented pattern on the touch sensitive graphical user interface of the electronic device. According to another aspect of the present invention, pressing a button determines that entry of input signal is complete. According to another aspect of the present invention, the displayed characters are English characters. According to another aspect of the present invention, the displayed characters are Korean characters. According to another aspect of the present invention, the displayed characters are used to enter Japanese characters. According to another aspect of the present invention, the displayed characters are punctuations. According to another aspect of the present invention, the displayed characters are 0-9 digits. According to another aspect of the present invention, the method is used to enter characters in more than one language. According to another aspect of the present invention, the method is used to enter characters in two languages. According to another aspect of the present invention, there is at least one segment to which three characters are associated to. According to another aspect of the present invention, there is at least one segment to which three characters are associated to and the characters are entered by tapping on the segment and dragging the finger from one side of the segment to the other side. According to another aspect of the present invention, there is at least one segment to which at least one character has been assigned and the character is entered by dragging finger on the segment twice. According to another aspect of the present invention, there is at least one segment to which five characters are assigned and the characters are entered by tapping or dragging finger on the segment from right to left, left to right, down to up and up to down.

It should be understood that the foregoing relates to preferred embodiments of the invention and that modifications may be made without departing from the spirit and scope of the invention as set forth in the following claims.

I claim:

1. A system for inputting data in an electronic device, the system comprising:
a segmented pattern on a touch sensitive graphical user interface of an electronic device, the segmented pattern having at least two segments;
a numeric value in the electronic device associated to each of the at least two segments;
a character table stored in the electronic device, the said character table having at least one set of numeric values associated to at least one character;
a set of characters displayed on the segmented pattern, each said character associated to at least one segment of the segmented pattern and the numeric value of that said segment is in at least one set of the numeric values stored in the character table and the said set is associated to the said character;
an input signal received on at least one segment of the segmented pattern to provide an input having numeric values associated with each of the segments;
means for determining that entry of input signal is complete;
a matched character determined by the electronic device according to input having numeric values, and the character table;
wherein the matched character is displayed on the touch sensitive graphical user interface of an electronic device and stored in the electronic device and the segmented pattern on the touch sensitive graphical user interface of the electronic device is reset.

2. A system as in claim 1, wherein the means for determining that entry of input signal is complete is a button.

3. A system as in claim 1, wherein the character table is extended by adding the direction of input signal on at least one segment of one character, and a matched character is determined by the electronic device according to input having numeric values, direction of input received on at least one segment of the segmented pattern and the character table.

4. A system as in claim 3, wherein the set of possible directions associated to the input signal is extended to include tapping on segments.

5. A system as in claim 1, wherein there is at least one segment to which at least three characters are associated.

6. A system as in claim 1, wherein the displayed characters include English characters.

7. A system as in claim 1, wherein the displayed characters include 0 to 9 digits.

8. A system as in claim 1, wherein the displayed characters include punctuations.

9. A system as in claim 1, further comprising a keyboard in communication with a touch sensitive graphical user interface of the electronic device, wherein said keyboard accepts keyboard character input.

10. A system as in claim 9, wherein accepting any keyboard character input on the keyboard denotes the end of the input signal.

11. A system for inputting data in an electronic device, the system comprising:
a segmented pattern on a touch sensitive graphical user interface of an electronic device, the segmented pattern having at least two segments;
a numeric value in the electronic device associated to each of the at least two segments;
a character table stored in the electronic device, the said character table having at least one set of numeric values associated to at least one character;
a set of characters displayed on the segmented pattern, each said character associated to one segment of the segmented pattern and the numeric value of that said segment is in at least one set of the numeric values stored in the character table and the said set is associated to the said character;
an input signal received on at least one segment of the segmented pattern to provide an input having numeric values associated with each of the segments;
a sequence of at least one segment determined by the electronic device according to the input having numeric values and the character table;
a matched character determined by the electronic device according to input having numeric values, the sequence and the character table;
wherein the matched character is displayed on the touch sensitive graphical user interface of an electronic device and stored in the electronic device and the segmented pattern on the touch sensitive graphical user interface of the electronic device is reset.

12. A system as in claim 11, wherein the character table is extended by adding the direction of input signal on at least one segment of one character, and a matched character is determined by the electronic device according to input having numeric values, direction of input received on at least one segment of the segmented pattern and the character table.

13. A system as in claim 12, wherein the set of possible directions associated to the input signal is extended to include tapping on segments.

14. A system as in claim 11, wherein there is at least one segment to which at least three characters are associated.

15. A system as in claim 11, wherein the displayed characters include English characters.

16. A system as in claim 11, wherein the electronic device backtracks and changes the sequence chosen from input signals received on at least one segment based on the results of matched characters or unmatched characters determined by the electronic device according to the input having numeric values and the character table.

17. A system as in claim 16, wherein a dictionary is used to analyze the result of the matched characters and backtrack to change the sequence chosen from input signals.

18. A system as in claim 11, further comprising a keyboard in communication with a touch sensitive graphical user interface of the electronic device, wherein said keyboard accepts keyboard character input.

19. A system for inputting data in an electronic device, the system comprising:
a segmented pattern on a touch sensitive graphical user interface of an electronic device, the segmented pattern having at least two segments and restricting input signals according to a set of predetermined rules;
a set of characters displayed on the segmented pattern;
an input signal received on at least a portion of a segment to provide an input having the coordinates of touched points;
a matched character determined by the electronic device according to input having the coordinates of touched points and at least one algorithm;
wherein the matched character is displayed on the touch sensitive graphical user interface of an electronic device and stored in the electronic device and the segmented pattern on the touch sensitive graphical user interface of the electronic device is reset.

20. A system as in claim 19, wherein at least one algorithm is a neural network based algorithm.
